(19) United States
(12) Patent Application Publication
(10) Pub. No.: US 2012/0271472 A1
(43) Pub. Date: Oct. 25, 2012

(54) SYSTEM AND METHODS FOR SUSTAINABLE ENERGY MANAGEMENT, MONITORING, AND CONTROL OF ELECTRONIC DEVICES

(75) Inventors: Josef Brunner, Muenchen (DE); Rene Seeber, Kassel (DE)

(73) Assignee: JOULEX, INC., Atlanta, GA (US)

(21) Appl. No.: 13/092,670

(22) Filed: Apr. 22, 2011

(51) Int. Cl. G06F 1/26

(52) U.S. Cl. 700/295

(57) ABSTRACT

Systems and methods for managing and monitoring a plurality of disparate electrical and/or electronic devices remotely, without the need for installing additional software on the devices. An energy management system installed within an organization's infrastructure communicates with devices from different vendors, makes, and models, housed at multiple geographically distributed facilities, for purposes of monitoring and managing several operational aspects related to such devices. Information related to various operational aspects retrieved from such heterogeneous, distributed devices is utilized in conjunction with energy management policies that remotely control or take actions with respect to the devices to achieve energy efficiency. Comprehensive energy management reports generated by an energy management system provide various details and analytics related to operational aspects of the managed devices.

### TECHNICAL FIELD

The present disclosure relates generally to sustainable energy management in buildings and facilities, and more particularly relates to methods and systems for providing the ability to monitor, analyze, control, and efficiently manage the energy consumed by network-connected devices and systems, including computers, VoIP phones, servers, routers, printers, copiers, HVAC systems, lighting systems, or any device or system connected to an information technology (IT) infrastructure.

### BACKGROUND

Providing and administering energy efficiency at buildings and facilities is a major concern for individuals and organizations. Sustained energy efficiency has a financial benefit by realizing reduced energy expenditure, and hence increased profitability and cost savings. In addition, reduced energy consumption has a societal benefit as it results in reduced greenhouse gas emissions and consequently lessens the detrimental effects of climate and ecological changes. Moreover, energy efficiency helps in saving natural resources to ensure secure and sustained energy supplies for the future.

Energy efficiency is commonly achieved by using energy-efficient devices and systems that consume less energy. For example, various kinds of commercially available electrical devices such as light bulbs, computers, monitors, laptops, printers, fax machines, photocopiers, televisions, phones, air conditioning units, washers, dryers, and several other such devices are commercially available that consume lower amounts of power as compared to their predecessor devices. However, as will be understood and appreciated, deploying energy efficient devices can involve an added cost burden to the device purchasers. This additional cost is largely due to the fact that such devices are manufactured with specialized electrical components that are technologically advanced and thereby consume less power, but are also more expensive than common, less-technically-advanced devices. Consequently, large enterprises and organizations that wish to achieve energy efficiency through a full-scale deployment of energy efficient devices will face an enormous cost upfront, and it may take a substantial amount of time to recoup the upfront cost of the devices through the cost savings they provide. Furthermore, even if such devices are deployed, this would be highly ineffective and inconvenient from an operational perspective as a large number of pre-existing devices that were fully functional would need to be replaced, transitioned, and/or potentially discarded.

Recently, the restructuring and deregulation of the global power utility industry has resulted in significant competitive, technological and regulatory changes. Independent power producers, power marketers and brokers have added a new and significant dimension to the task of managing and maintaining a reliable power supply system that also has potential for cost savings. These days, even private households are now able to produce their own self-generated electricity—for example, from solar panels or alternative power generation systems, and feed them into their power supply grid. Thus, a comprehensive and detailed energy efficiency analysis is fundamental to energy efficiency management. Further, such analysis will identify and assess the saving potential across private households and corporate organizations. The completeness of this assessment is of specific importance in order to discover, determine, and to evaluate all available saving potentials and to set right priorities of actions. For example, different saving potentials can be harnessed by using different kinds of electrical equipment in combination with different sources of electrical energy (hydroelectric, nuclear, coal, natural gas, etc.) supplied by different power utilities each having a different energy pricing (measured in price/kilowatt-hour). From this systematic analysis, various energy efficiency projects are developed, which lead to tremendous reduction of the overall energy consumption as well as optimized energy efficiency management methodologies. These projects are of huge benefit to large-sized corporate organizations and enterprises with business divisions, offices, factories and plants distributed worldwide.

Several enterprises and corporate organizations have establishments that are located at different places, e.g., call centers (for handling customer service requests), data processing centers, office buildings, satellite offices or campuses, etc., that are geographically distributed. It is important for an IT manager working at such an organization to perform administrative functions on various types of electrical equipment installed at the facilities. For example, different types of electrical equipment, such as racks and servers, store data at such establishments. These racks and servers typically need to be monitored for consumed electrical power, and if one of these components fails or produces excess heat due to prolonged operation, it may need to be turned off.

Conventional systems for energy management utilize installation of specific software agents on each piece of electrical equipment to be monitored. Sometimes, this installation step is performed manually for each item of equipment. At other times, it is automated via a centralized installation server that manages installation of the software agent on various equipment. In either case, the cost of installation (and subsequent maintenance and upgrade) is typically proportional to the number of devices or pieces of equipment that require monitoring and management. For a large organization, this results in a significant overhead in cost and resources. Furthermore, if additional equipment is installed in such a facility, reconfiguration of every item of equipment in that facility must be performed, which is highly inefficient and cumbersome.

To complicate matters, most facilities have a variety of types of electronic or electrical equipment that maintained within the facility's IT infrastructure, such as desktop computers, servers, Voice-over-Internet-protocol (VoIp) phones, laptops, routers, HVAC systems, lighting equipment, etc. Each of these devices may be of a different type, brands, or model. For instance, a given organization or facility might utilize DELL™ desktops, COMPAQ™ desktops, IBM™ servers, CISCO™ VoIp phones, APPLE™ laptops, HP™ laptops, CISCO™ switches, NETGEAR™ routers, and various other devices from a variety of manufacturers. Even for a particular brand, there could be several models. Further, entities, corporate organizations and enterprises have business divisions, offices, factories and plants distributed worldwide. In such a scenario, an organization can realize cost savings by intelligently monitoring, analyzing, and managing the power consumed by various network connected devices. A very basic example would be to turn off all unused desktop computers and printers after office hours when they are not in use. Another example would be using an energy management system to measure energy consumption of various devices and map them to their corresponding organizational units. However, remote management/administration and also measurement/monitoring of energy usage of such a wide variety of devices that are distributed across different geographical locations is a very challenging task, and has not been heretofore addressed.

Therefore, there is a long-felt but unresolved need for a system or method that enables, in virtually real time, monitoring, management, analyzation, and control of a plurality of devices across numerous facilities distributed in multiple geographical locations. Moreover, there is a need for such a system to support multiple device types, brands, vendors and manufacturers, and not remain specific to certain devices, or manufacturers. There is a further need for a system that provides quick and easy setup and seamless integration with existing devices and infrastructure, without the need for installing additional software on the devices. Also, the system should have capability for automatic discovery of new electronic equipment when the equipment is installed at a facility, and provide detailed and comprehensive energy efficiency analysis reports in virtually real time, covering aspects of power consumed by various devices, different power sources, and from various power utilities.

### BRIEF SUMMARY

Briefly described, and according to one embodiment, aspects of the present disclosure generally relate to systems and methods for managing and monitoring (in real time as well as in non-real time) a plurality of electrical and/or electronic devices remotely via a consolidated system without the need for installing additional software on individual devices. According to one aspect of the present disclosure, and described in greater detail herein, an energy management system (EMS) is easily and efficiently installed either at a physical computer located in a facility or a virtual computer located in a cloud computing environment. According to another aspect of the present disclosure, one or more facilities that are to be controlled are connected to each other via a corporate Local Area Network (LAN) or Wide Area Network (WAN). Facilities that are controlled by embodiments of the EMS generally include a variety of discrete types of assets and devices that consume energy or power.

According to one embodiment of the present disclosure, aspects of the present EMS manage, monitor, and control assets housed at one or more facilities. This includes several tasks, for example, retrieval of various kinds of data regarding the assets, including measurement of power consumed by various assets located at different geographically distributed facilities. Furthermore, aspects of the present disclosure relate to sophisticated methods of processing various kinds of asset data retrieved from different type of assets associated with different vendors, makes, and models, for monitoring and management of such via a single interactive dashboard interface. According to another embodiment of the present disclosure, management of such a wide variety of distributed assets further include applying various policies and rules for purposes of providing energy efficiency.

Additionally, aspects of the present disclosure are directed to generating various reports containing operational information relating to the assets, actual (and projected) cost savings and greenhouse emissions, as a consequence of applying various policies and rules. Moreover, such reports provide detailed as well as summarized analytics related to energy management that are utilized by organizations (entities) and private individuals to develop future strategies for optimum energy management.

### BRIEF DESCRIPTION OF THE DRAWINGS

The accompanying drawings illustrate one or more embodiments of the disclosure and, together with the written description, serve to explain the principles of the disclosure. Wherever possible, the same reference numbers are used throughout the drawings to refer to the same or like elements of an embodiment, and wherein:

FIG. 1 illustrates a high-level overview of an embodiment of an energy management system (EMS).

FIG. 2 shows an exemplary EMS architecture comprising various software modules, engines and other similar elements, according to one embodiment of the present system.

FIG. 3 shows a sequence diagram illustrating computer-implemented method steps involving various components of an embodiment of the present system and their interactions with each other.

FIG. 4 is a flowchart showing a summary of high-level, computer-implemented method steps illustrating overall EMS processes, performed by various software modules and engines of the EMS, according to one embodiment of the present system.

FIG. 5 consisting of FIG. 5A and FIG. 5B is a flowchart showing an exemplary computer-implemented process for configuring an embodiment of the EMS (involving integrating devices with the EMS).

FIG. 6 consisting of FIG. 6A and FIG. 6B is a flowchart showing an embodiment of computer-implemented steps performed by an EMS in order to monitor and retrieve information related to power consumed by various devices.

FIG. 7 consisting of FIG. 7A and FIG. 7B is a flowchart showing computer-implemented steps involved in executing various policies for management of energy efficiency for devices, according to one embodiment of the present system.

FIG. 8 is an exemplary policy table (stored in an EMS database) illustrating various policies for management of energy efficiency for devices, according to one embodiment of the present system.

FIG. 9 is an exemplary device table (stored in an EMS database) comprising several attributes related to devices, involved in performing management of energy efficiency for devices, according to one embodiment of the present system.

FIG. 10 is an exemplary power table (stored in an EMS database) comprising power and energy profile information for various devices, according to one embodiment of the present system.

FIG. 11 consisting of FIG. 11A and FIG. 11B includes screenshots of exemplary EMS interfaces showing overviews of management of energy efficiency for devices, according to one embodiment of the present system.

FIG. 12 consisting of FIG. 12A, FIG. 12B and FIG. 12C includes screenshots of exemplary EMS interfaces for creating policies for management of energy efficiency for devices, based on several conditions related to time, location, etc., according to one embodiment of the present system.

FIG. 13 is a screenshot of an exemplary EMS interface for management of energy efficiency for devices, according to one embodiment of the present system.

FIG. 14 is a screenshot of an exemplary EMS interface showing summary reports and statistics obtained by performing management of energy efficiency for devices, according to one embodiment of the present system.

FIG. 15 consisting of FIG. 15A, FIG. 15B, FIG. 15C, and FIG. 15D are screenshots of exemplary EMS interfaces for configuring various settings/options for an EMS, according to one embodiment of the present system.

### DETAILED DESCRIPTION

Prior to a detailed description of the disclosure, the following definitions are provided as an aid to understanding the subject matter and terminology of aspects of the present systems and methods, are exemplary, and not necessarily limiting of the aspects of the systems and methods, which are expressed in the claims.

### Definitions/Glossary

Action: an activity or task that is executed under the direction of an energy management system (EMS) in connection with performing energy efficiency management or monitoring of an asset. Examples of actions performed on assets include, but are not limited to, changing the power state of the asset, viz. from power on mode to hibernate mode, notifying an EMS administrator via email regarding the change of the power state of an asset, running a script written by a programmer, etc.

Asset: electrical or electronic equipment that is connected to an information technology (IT) infrastructure. Generally represents a unique network-attached component which is managed by an EMS. For example, assets may include, but are not limited to, laptop computers, desktop computers, servers, mainframe computers, Voice-Over-Internet-Protocol (VoIp) phones, routers, switches, printers, copiers, scanners, lighting equipment (bulbs, lamps, fluorescent tubes, etc.), HVAC equipment, fans, generators, motors, electrical machines, etc. An asset may also comprise a device that can be controlled over an IT network. Generally, assets are identified with several attributes, for example, a device identifier, a device type, a network address, a location, a business unit, power state, power consumed, etc. Information relating to assets within a facility or facilities is generally maintained within an asset management system. Generally synonymous with device.

Asset Connectors: a suite of software tools in an EMS that is used to discover and import information relating to assets into the EMS, with the help of one or more asset management systems. An exemplary function of an asset connector includes importing information relating to all WINDOWS™ computers from an asset management system, such as “Active Directory”, into the EMS. Generally synonymous with asset connector modules.

Asset Management System: a suite of asset management tools provided by an existing network system and/or facility infrastructure. For example, asset management systems generally include elements of software and hardware that manage information relating to assets or devices operating in a facility. Examples of asset management systems include, but are not limited to, MICROSOFT™ Active Directory, or CISCOWORKS™.

Business Unit: a division or unit of a corporation or entity associated with performing one or more functions. Examples of different types of business units include, but are not limited to, Sales, IT, Engineering, Marketing, etc.

Condition: a mode of operation or working state of an asset that is used to determine one or more action(s) to be taken with respect to the asset. Generally, conditions can be based on date/time, asset type, applications or programs running/not running on assets, custom scripts written by a programmer, business units, asset locations, etc. A rule (defined below) generally includes one or more conditions.

Database Connector: a standard software interface that allows an application to have access to data made available by an online service, a database management system (MS SQL, ORACLE™, FIREBIRD™, MYSQL™, etc.) or a standard Internet service such as email. Database Connectors allow programmers to treat disparate data sources as if they were sets of database tables. Typically, they are made to be independent of programming languages, database systems, and operating systems.

Device: Generally synonymous with Asset.

Device Information: data or attributes pertaining to a specific device within a facility. Examples of device information may include, but are not limited to, device type, device model number, manufacturer, network name/address associated with device, location of device, business unit associated with the device, operating system running (if any) on the device, etc. Generally synonymous with asset information.

Device Profile: an abstract representation comprising several attributes of information associated with an asset or device as obtained using a combination of asset management systems, asset connectors, and device proxies. Generally, device profiles are stored in an EMS database to enable subsequent retrieval of information and actions with respect to the device. Examples of different attributes of information may include, but are not limited to, device type, device model number, manufacturer, network name/address associated with device, location of device, business unit associated with the device, operating system running (if any) on the device, etc.

Device Proxy: a software tool or module in an embodiment of the EMS that implements low-level communication protocols for communication with discrete types of devices or asset management systems. Examples of functionalities of device proxies include, but are not limited to, support for protocols such as WINDOWS™ Management Instrumentation (WMI) to communicate with WINDOWS™ machines, support for Secure Shell (SSH) for LINUX™ and/or APPLE™ machines, and other such protocols. Generally synonymous with device communications module.

Energy Information: data or information relating to energy characteristics of a given electronic device. Examples of energy information include, but are not limited to, power consumed by a device, energy state of the device (e.g., on mode, off mode, standby mode, hibernate mode, startup mode, shutdown mode), utilization of the device (e.g., high usage, idle usage, etc.), and the like. Generally synonymous with current energy information.

Energy Pricing Rate: price of energy as charged by a power utility company, expressed in price/kWh, where kWh is an abbreviation for kilowatt hour.

Energy Management System (EMS): a system constructed as described in this document, that enables remote energy efficiency management, monitoring, control, and analysis of a collection of assets that are housed in one or more facilities.

Facility: an abstraction that represents a collection of one or more assets housed together. For example, a facility may include a hospital, university, airport, one or more business units, a factory, a laboratory, a data center or some other similar site, and may also include one or more buildings (or floors inside a building) that houses assets. A facility may comprise a virtual or physical segregation of assets. Generally, one or more facilities are connected to an EMS via an IT network.

IP: abbreviation for Internet Protocol (IP), which is a communications protocol that enables delivery of data across a digital network.

Location: a physical (geographical) place where a facility is located. A location may include a continent, country, city, town, street, building, room, or any other geographical place.

Policy: a collection of one or more rules (defined below) relating to management and/or control of one or more electronic devices. Sometimes synonymous with rule and energy management policy.

Power Profile: a set of information attributes pertaining to power usage of an asset, as obtained using a combination of asset management systems, asset connectors, and device proxies. Examples of different attributes of information include, but are not limited to, real-time power consumption of device, duration of time for which a device has been operational, power state of device (on/off/hibernate modes), and various other power-related details.

Rule: an instruction to conduct a specific action relating to one or more assets depending on satisfaction of a set of conditions. For example, rules may be used to automatically change the power state of an asset depending on the satisfaction of various predetermined conditions. Generally, rules are created by an EMS user or system administrator to accomplish various energy management goals within an organization and/or facility. In on case, rules can have mutual interdependencies. Rules generally include at least one condition and one corresponding action, but may include a variety of conditions and/or set of actions. Generally, rules for an asset are executed according to a pre-specified sequence, before moving on to a next asset specified in the rule. Examples of rules include, but are not limited to, hibernate all assets during lunch hour and on weekends, turn off power for assets at a specific business unit for a predetermined time interval, send an email communication to an EMS user when a given device is manually activated, hibernate or turn off a given device if its power output eclipses a predefined level, and numerous others.

Software Agent: a software program (sometimes called a service or daemon) that is installed and runs on an IP-enabled device for collecting information and transferring it over a network to a central location, typically according to a standard format so that it can then be collected over the network from the central location.

VoIP: abbreviation for Voice-Over-Internet-Protocol. VoIP is a family of Internet technologies, communication protocols, and transmission technologies for delivery of voice and/or multimedia data over Internet Protocol (IP) networks.

Widget: a reusable tool used in graphical user interfaces, usually for the purposes of customization of displayed information on an interface.

### Overview

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates.

Aspects of the present disclosure generally relate to systems and methods for managing and monitoring a plurality of assets (in real time as well as in non-real time) using an energy management system (EMS). Additional aspects relate to easily and efficiently installing (for example, with a simple plug-and-play mechanism) an EMS to manage, monitor, and control pre-existing assets at one or more facilities. Also, aspects of the present disclosure relate to normalizing asset information across varying vendors, makes, and models of assets that are located at various geographically distributed facilities, for management of heterogeneous, distributed assets via a single interactive dashboard interface. Further, aspects of the present disclosure are directed to generating various reports containing operational information relating to the assets, actual (and projected) cost savings and greenhouse emissions based on actions taken with respect to the assets, and analytics related to energy management that are utilized by organizations (entities) and private individuals to develop strategies for optimum energy efficiency management.

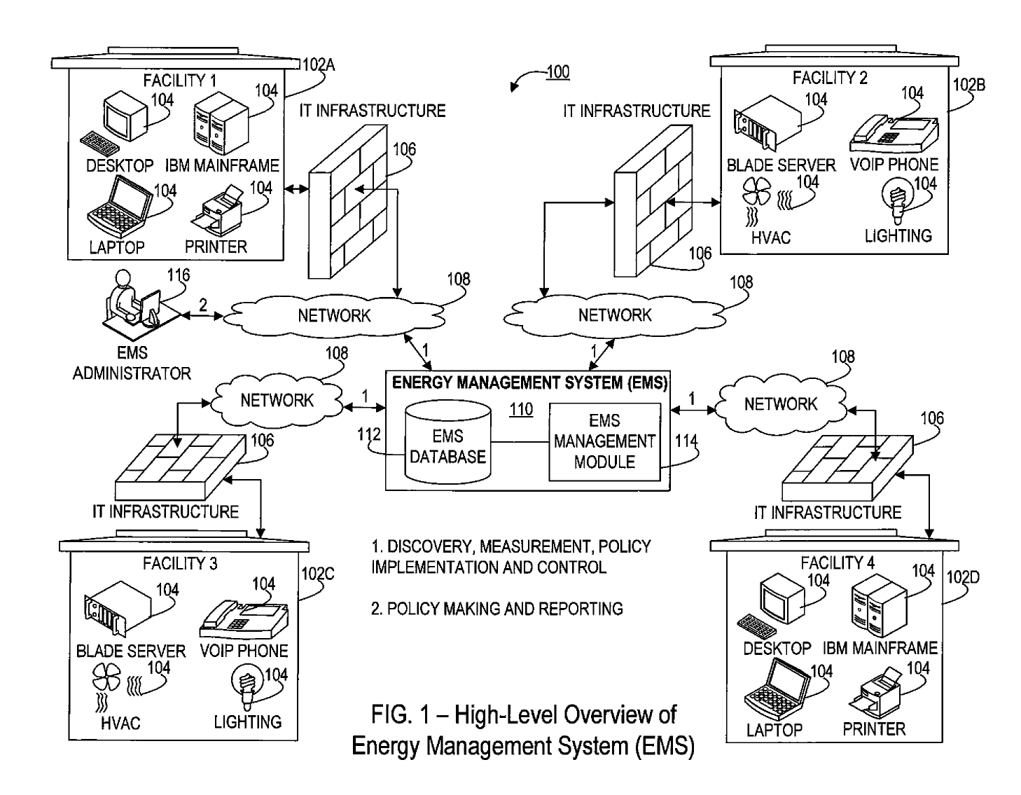

Referring now to the figures, FIG. 1 illustrates an overview 100 of an embodiment of an energy management system (EMS) 110 in an exemplary environment, constructed and operated in accordance with various aspects of the present disclosure. According to one exemplary embodiment, an organization has multiple facilities 102A, 102B, 102C and 102D at different geographical locations. Such facilities are interconnected via network(s) 108. According to the embodiment shown, the EMS monitors, manages and controls power consumed by assets 104 housed in facilities 102A, 102B, 102C and 102D via a network 108. As will be understood and appreciated, these facilities could be co-located at the same geographic location, for example, the facilities could indicate various floors in a building, or they may be distributed geographically at various locations. For example, a facility could be in Atlanta, another facility could be in Tokyo, and so on.

Generally, facilities may include airports, hospitals, universities, military bases, government structures, communications service installations, data processing centers, office buildings, scientific laboratories, sewage pumping stations, retail outlets, residential complexes, private homes, and other similar facilities. A facility usually houses multiple electrical or electronic assets 104 belonging to different device types, brands, vendors and manufacturers, connected to an IT infrastructure 106. As shown, for example, in FIG. 1, hypothetical facility 102A includes a desktop, an IBM™ mainframe computer, a laptop and a printer. A facility 102B comprises a blade server, a VoIP phone, a HVAC system and lighting equipment. Hypothetical facilities 102C and 102D include various other types of equipment and devices. As will be understood, various numbers and types of electrical and electronic devices can be housed in a facility, and there is no limitation imposed on the number of devices, device types, brands, vendors and manufacturers that may be included within an organization or the organization's facilities. Further, no limitation is imposed on the number of facilities that can be controlled by the EMS, or the locations of such facilities.

Additionally, as will be understood, many types of assets contain central processing units (CPU's) or microprocessors that are driven by multiple software programs and/or operating systems, for example in laptops, desktops, switches, routers, and other such assets. Examples of common operating systems include (but are not limited to) MICROSOFT WINDOWS™, APPLE™ OS X, or any UNIX/LINUX™ based operating system. It will be further understood that virtual assets, for example, PCs running multiple operating systems like WINDOWS 7™, LINUX™, WINDOWS XP™, etc. can also be monitored and managed by embodiments of the EMS.

According to one embodiment of the present disclosure, an EMS 110 is installed on a physical server or a general purpose computer in a facility 102 that is connected to an IT infrastructure 106. According to another embodiment, the EMS 110 is hosted on a virtual computer (connected to an IT infrastructure 106) housed in a facility 102. According to yet another embodiment, the EMS 110 resides in a third party server in a cloud computing environment and communicates with assets 104 housed in facilities 102 via networks 108. Although not shown in FIG. 1, it can be understood that IT infrastructure 106 at facilities 102 may include one or more gateways/firewalls that provide information security (from unwarranted intrusions and cyber attacks) to facilities and also ensures operating compatibility between an IT infrastructure 106 and networks 108. Generally, in those embodiments in which a firewall is used, the EMS operates behind the firewall of the organization.

As shown in FIG. 1, an embodiment of the EMS 110 includes an EMS management module 114 and an EMS database 112 for performing the tasks of energy efficiency management of a plurality of assets 104 housed in multiple geographically distributed facilities. Generally, the EMS management module 114 includes various software algorithms and sub-modules that enable energy efficiency management, including monitoring, analyzing and control of various aspects related to power or energy states of assets (on/off/hibernate), energy consumed by assets in real-time, effect of energy consumption on carbon emissions into the environment, cost as well as savings (if any) associated with energy consumption, and various other such aspects. Generally, the EMS database 112 stores various types of device data, power consumption data, and other information relating to the EMS.

As will be understood by a person skilled in the art, remote energy efficiency management generally entails two-way communication of power related information between assets 104 and the EMS 110. This communication proceeds over a network 108 using one or the other services, such as a Web-deployed service with client/service architecture, a corporate Local Area Network (LAN) or Wide Area Network (WAN), or through a cloud-based system. Information generally travels through an IT infrastructure 106 that is pre-installed at facilities 102. IT infrastructure 106 is retrofitted or pre-installed with asset management systems (not shown in FIG. 1) that provide a two-way communication link between individual assets 104 and EMS 110 that is external to individual assets 104. An asset management system typically includes information relating to an inventory of devices or assets maintained within the asset management system. (Further details of asset management systems are described in the glossary above and elsewhere in this document.) Typically, multiple assets 104 are connected to an asset management system. Generally, several asset management systems form an integral part of IT infrastructure 106 at facilities 102.

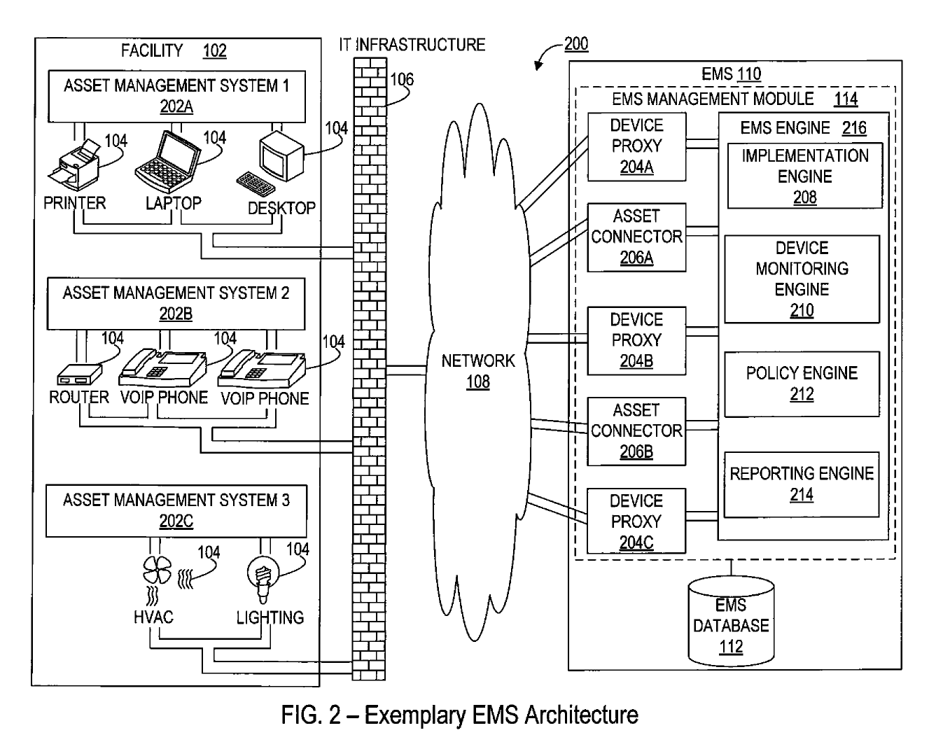

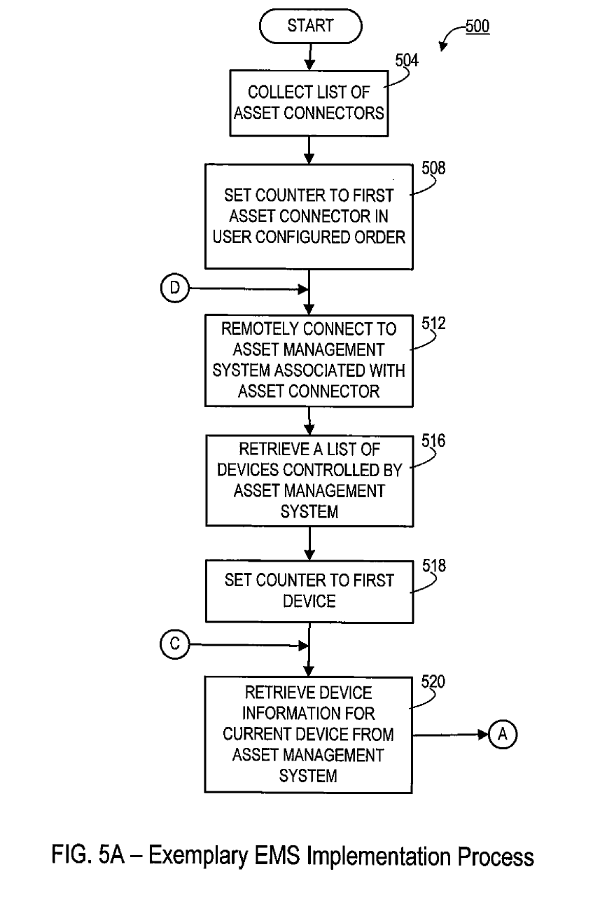

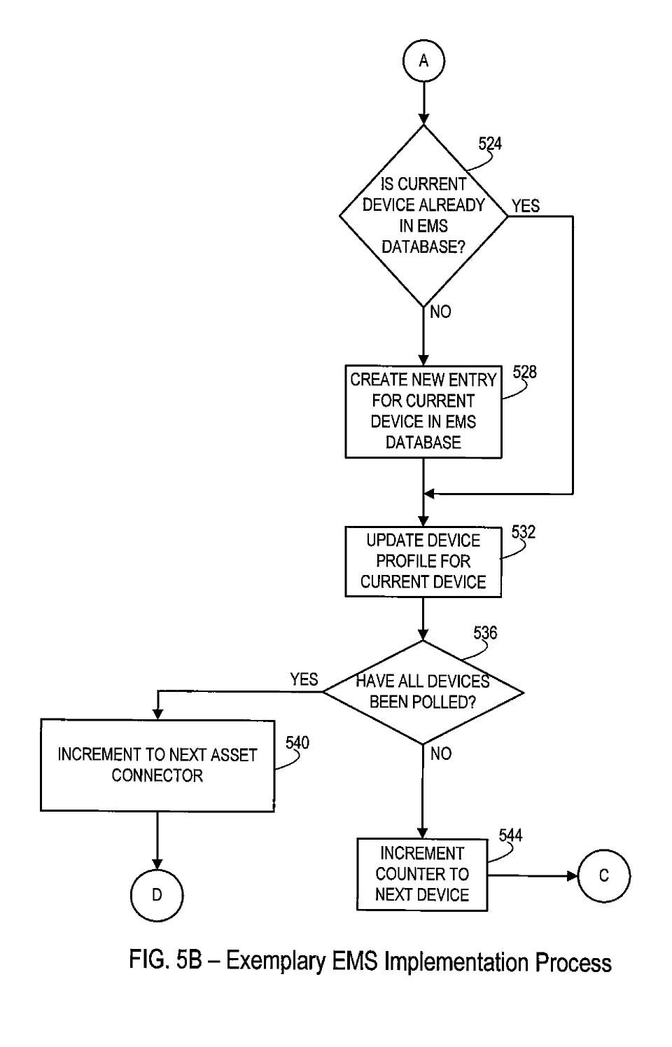

As mentioned above, the EMS 110 (specifically, various components of EMS management module 114) generally leverages functionalities of asset management systems in order to integrate individual assets 104 into an unified framework for the purposes of managing and monitoring individual assets 104. Architectural details of one embodiment of the EMS 110 showing constituent software modules/components of the EMS management module 114 are shown in FIG. 2, and flowcharts showing processes performed by the various modules are described in FIGS. 5A-7B (and described in detail below). According to one embodiment, in an exemplary facility 102, assets such as computers and printers are connected to an asset management system (as can be seen in FIG. 2) that controls such assets. Similarly, VoIP phones, routers/switches/access points are connected to another asset management system, and even further, HVAC, lighting equipment and fans are connected to yet another asset management system. Examples of commercially available and standard asset management systems used in most facilities 102, include (but not limited to) MICROSOFT™ Active Directory, MICROSOFT™ System Center Configuration Manager, ENTERASYS™ Netsight, CISCOWORKS™, and many other such systems. Furthermore, in case assets are not managed by standard asset management systems, such assets can be integrated manually or using database connectors (for example, using ODBC import) or file connectors (for example, using CSV file import) into an EMS 110.

In accordance with aspects of the present disclosure, when an embodiment of the EMS 110 is running under normal operating conditions, information is continually retrieved from assets, at periodic intervals of time by components of the EMS management module 114. Such information is utilized by components of EMS management module 114 to monitor various attributes of assets, for example, power consumed, duration for which an asset has been operational, power state of the asset (on/off/hibernate modes), and various other attributes related to the power profile of an asset. Additionally, as will be understood by a person of ordinary skill in the art, when the EMS 110 is first installed/configured, or when new assets are introduced for the first time, information retrieved from assets 104 is imported automatically into the EMS 110 via the asset management systems. This information is periodically synchronized/updated in order to ensure all device data is up-to-date. Examples of such information includes asset type, model number, manufacturer, network name/address associated with an asset, business unit and various such details and device profile attributes.

Information pertaining to individual assets, retrieved during configuration/implementation of the EMS as well as during asset monitoring, is stored in the EMS database 112 for subsequent processing relating to energy efficiency management those individual assets. During implementation of the EMS, such data is provided by asset management systems that provide a communication link for the EMS 110 to acquire data about individual assets 104. During monitoring and control of the assets, an asset management system may or may not be necessary (as described in greater detail below). As shown in FIG. 1, a summary of high-level functions (indicated by numbers “1” and “2”) performed by the EMS 110 include discovery of new assets, measurement of power consumed by newly introduced as well as pre-existing assets, implementation of various policies and monitoring/control of various assets.

After various assets 104 have been integrated into an embodiment of the EMS 110, management and control of individual assets 104 is effected by the EMS 110 by applying various pre-determined rules/policies that govern how and when assets 104 are to be controlled (e.g., turned off/on) in order to achieve energy efficiency, with the help of information stored in the EMS database 112. Actions associated with these rules are communicated to individual assets for executing on individual assets. For example, a rule could indicate turning off assets in a certain facility at 7 pm and turning them on at 6 am. Another rule could indicate turning off all assets at a specific business unit for a certain number of days. Yet another rule could indicate turning off laptops and desktops that are not running a particular application, for example programs like MICROSOFT™ OFFICE™ or MICROSOFT™ POWERPOINT™. Further, another rule could be to hibernate VoIP phones and workstations/servers on weekends. Another rule might include notifying a system administrator when a certain event occurs. According to one embodiment of the present disclosure, such rules are specified/created by an EMS administrator or user 116 within the EMS, and then these rules are executed on individual assets 104 based on satisfaction of certain conditions or criteria.

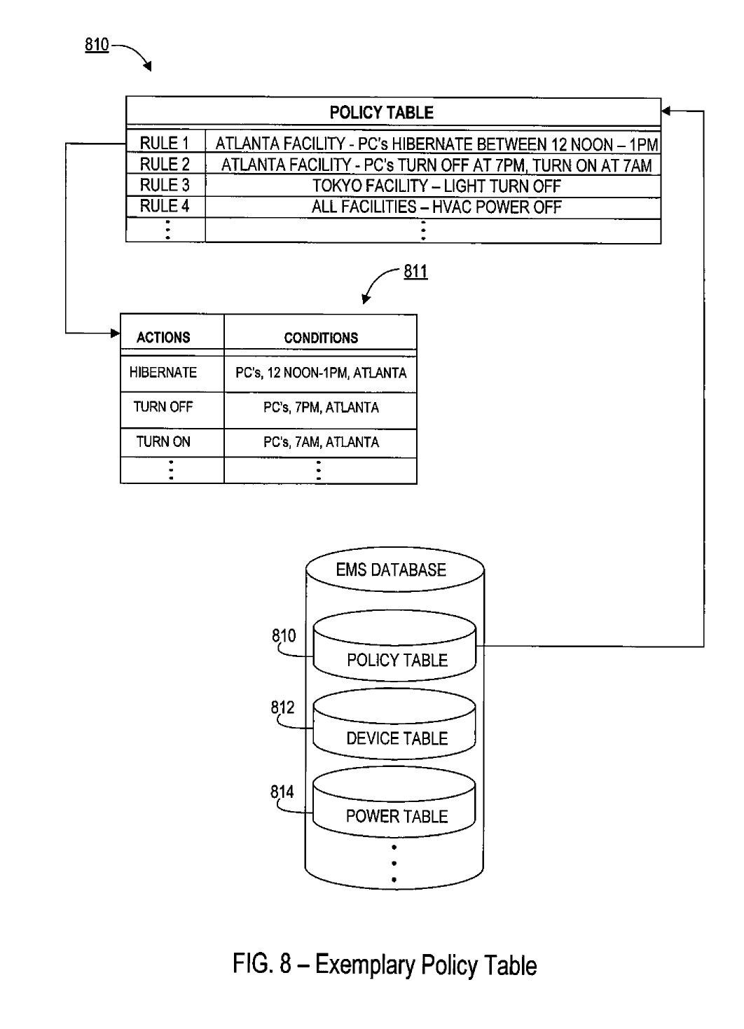

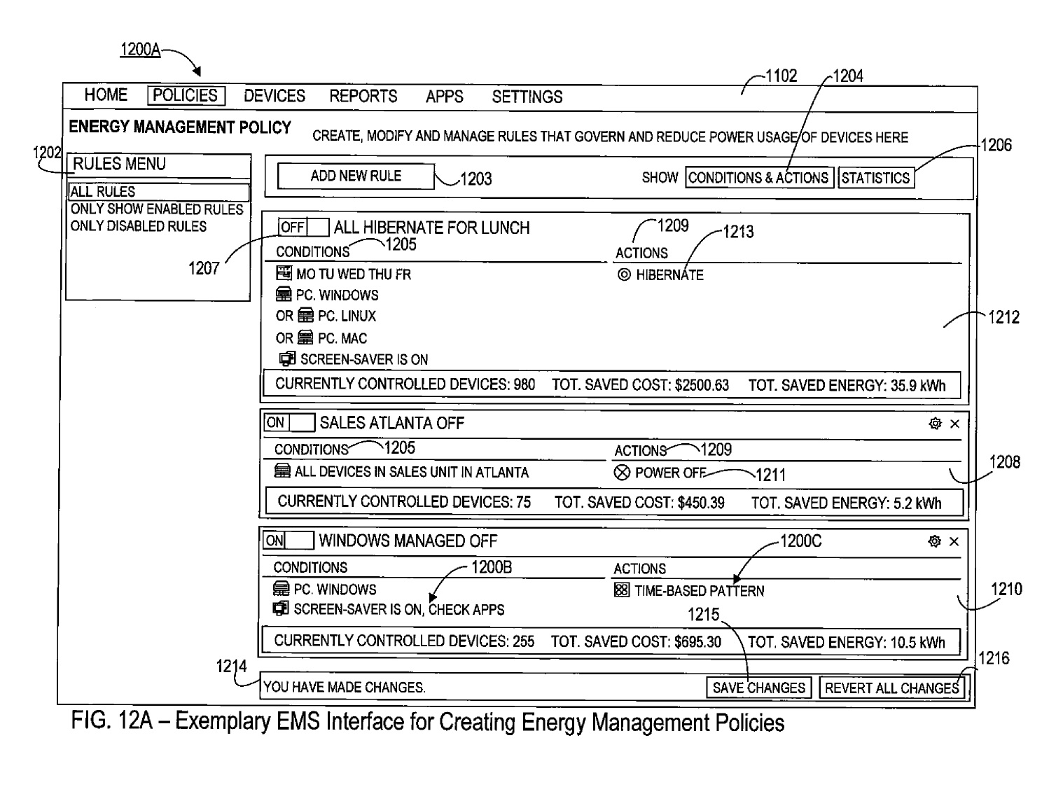

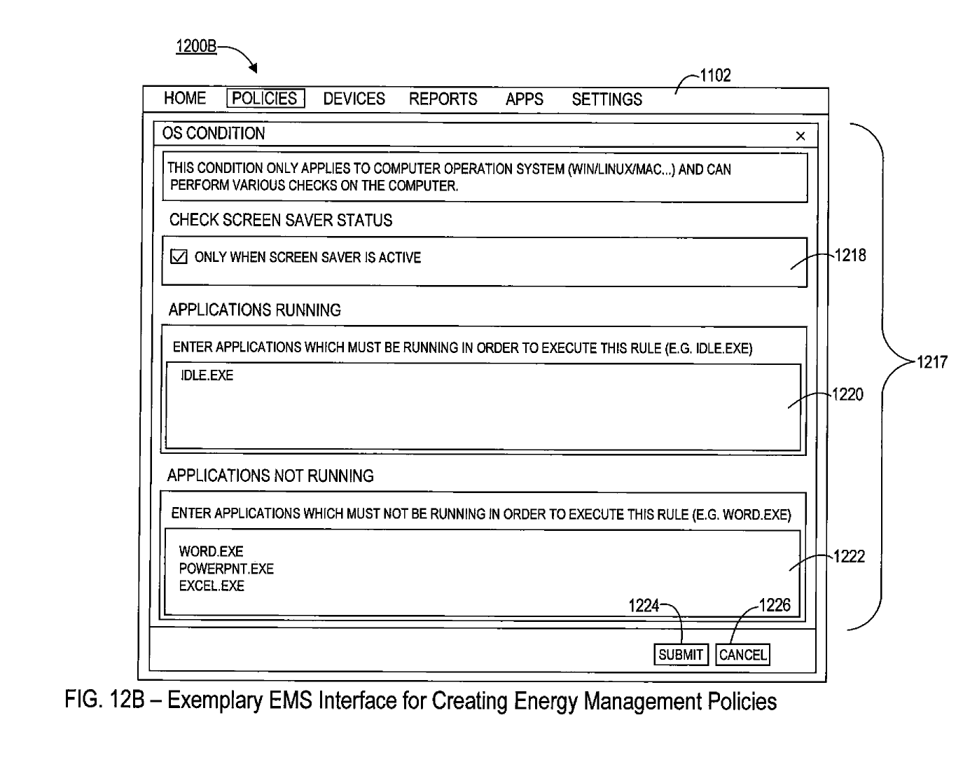

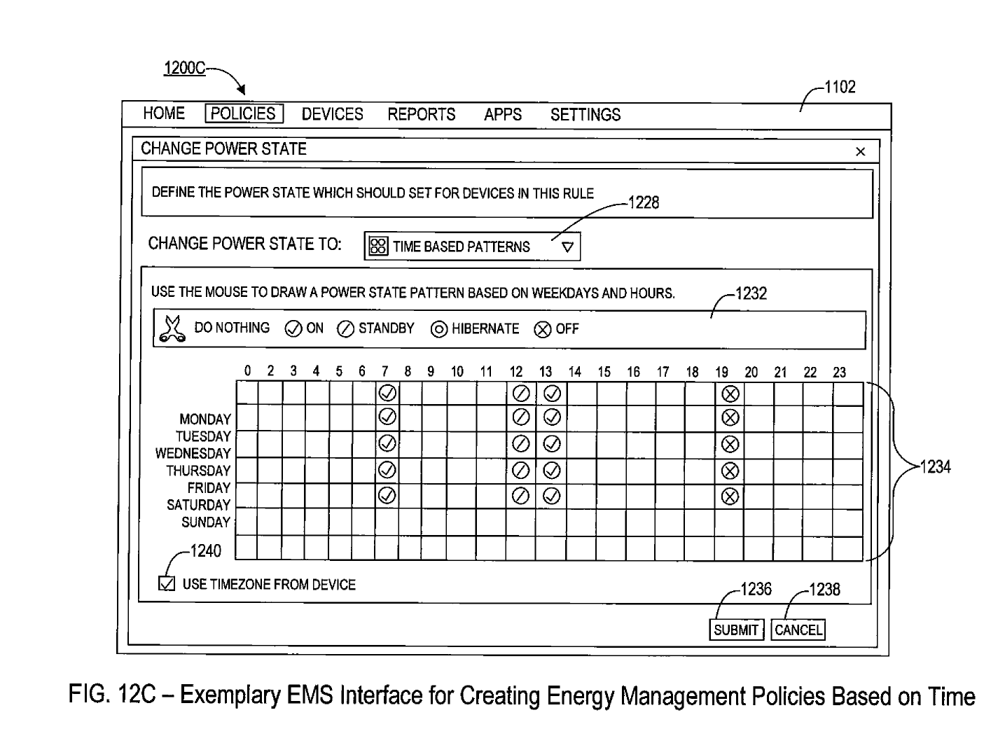

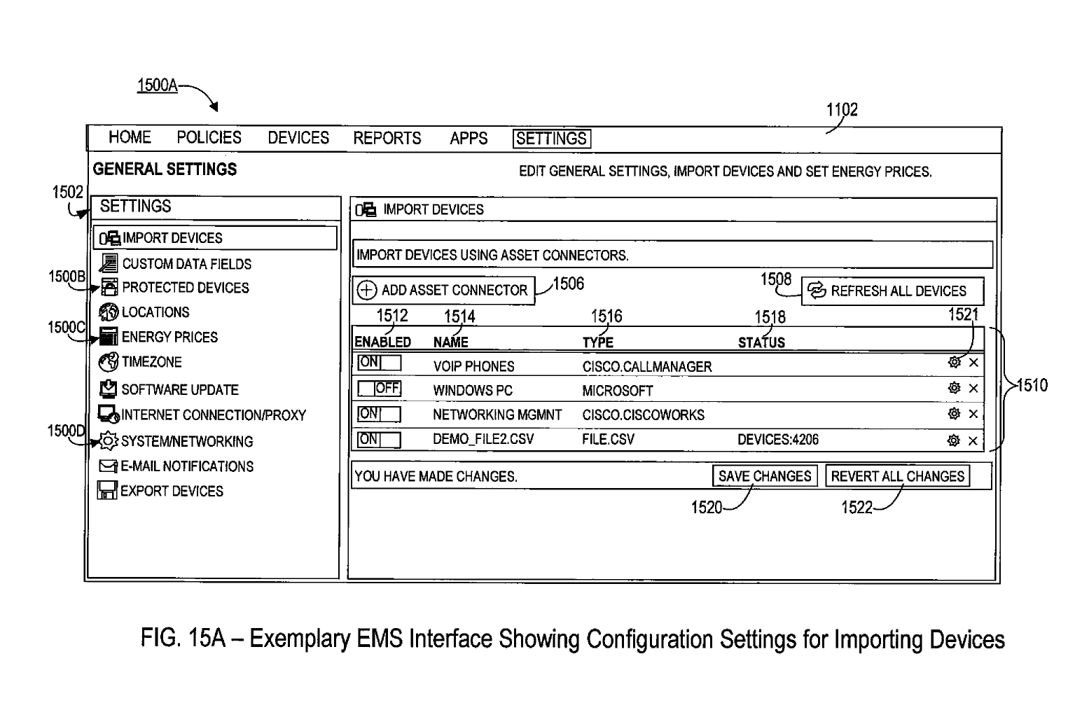

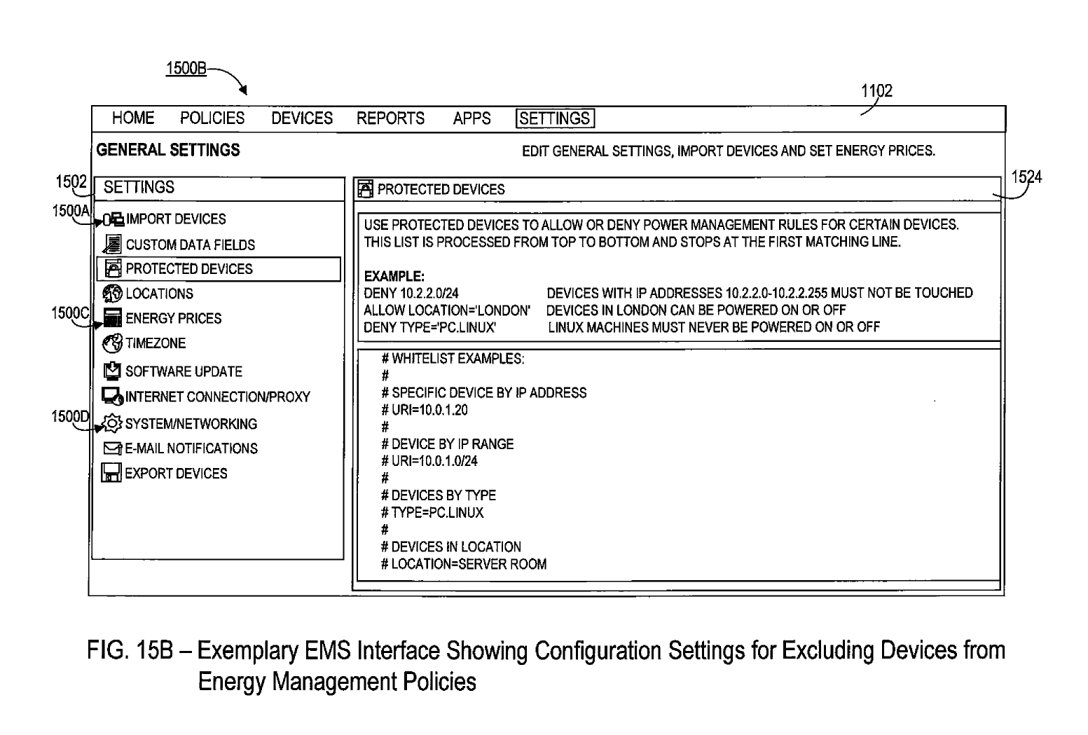

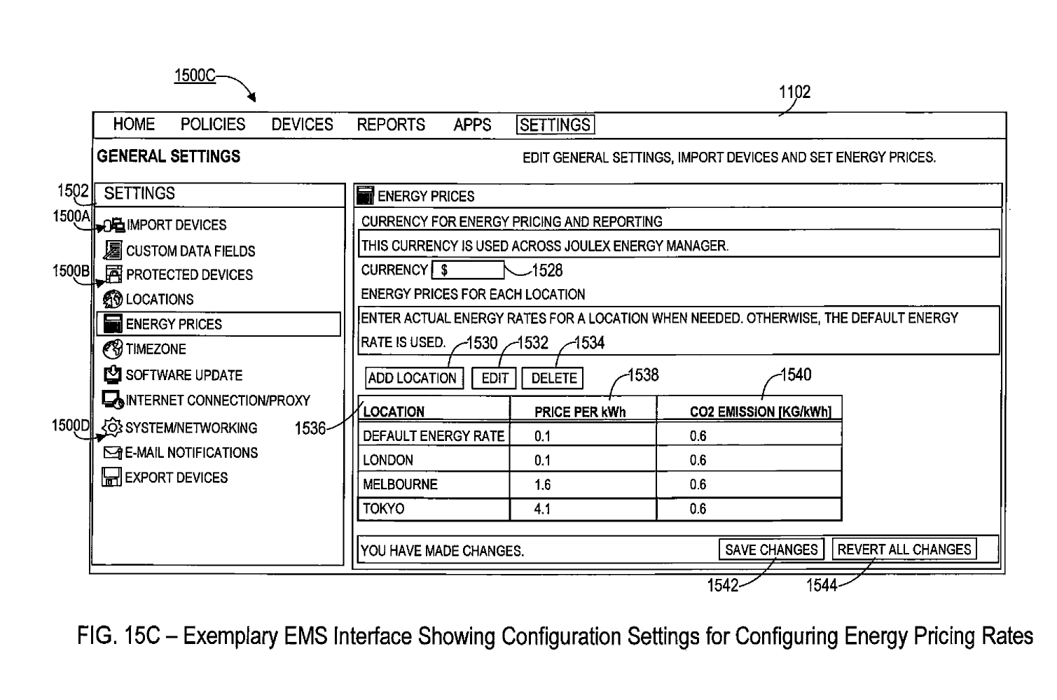

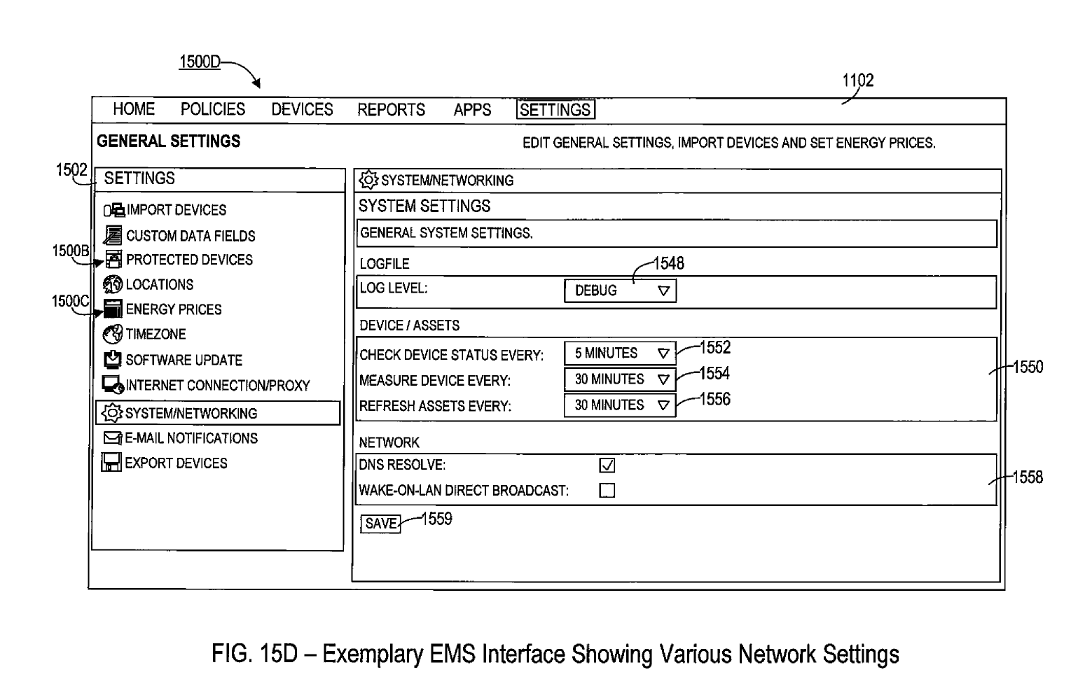

Generally, the EMS administrator 116 specifies such policies (or, generally speaking, rules) and reviews energy efficiency management reports provided by EMS 110. An exemplary high-level summary of tasks performed by an EMS administrator 116 are indicated with a number “2” in FIG. 1. Examples of exemplary policies are shown in FIG. 8 in a datatable saved in the EMS database 112. Further, screenshots of exemplary policies are provided in FIGS. 12A-12C, and FIG. 15B. These policies and figures are described in greater detail elsewhere in this document.

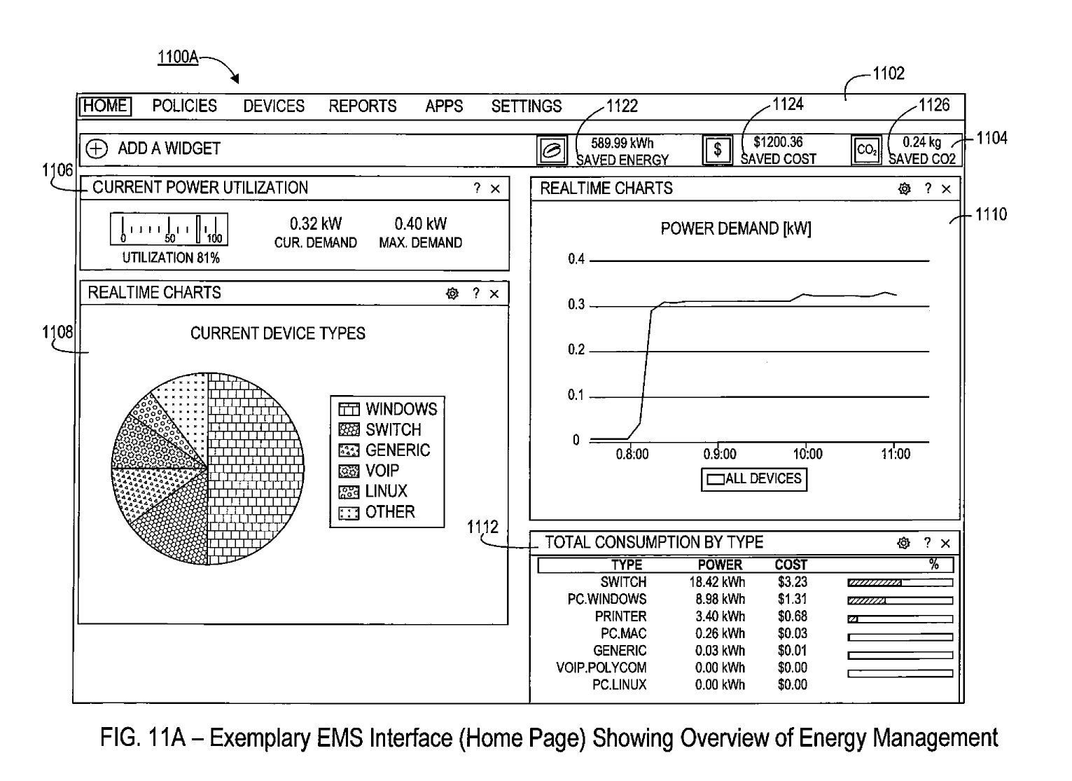

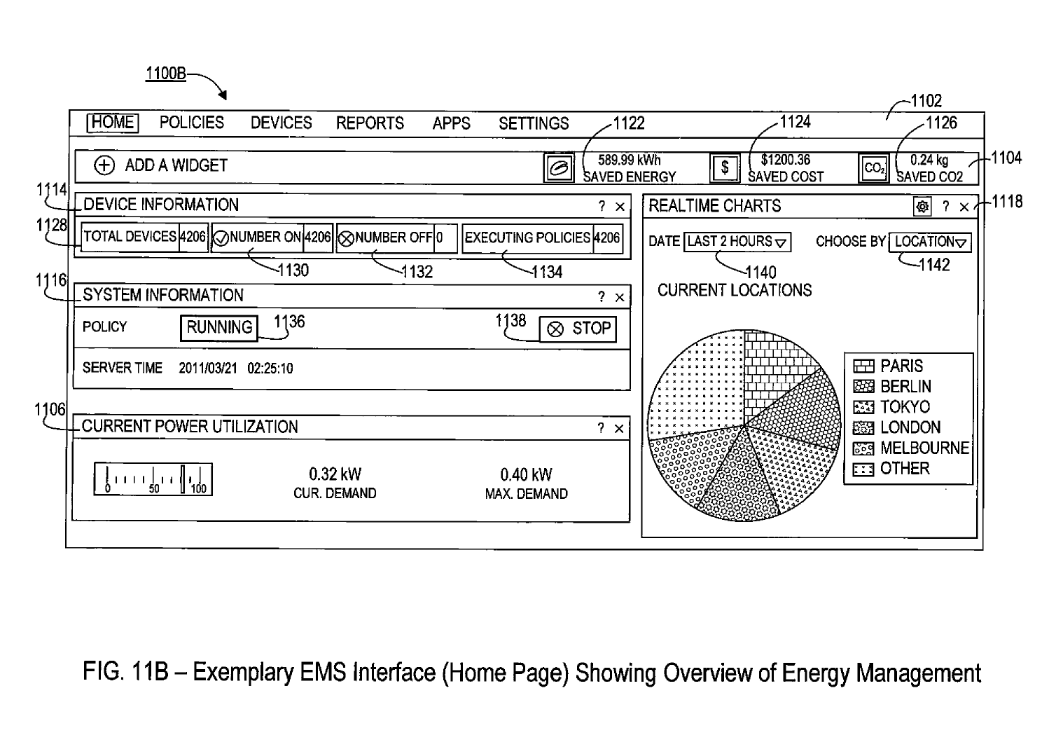

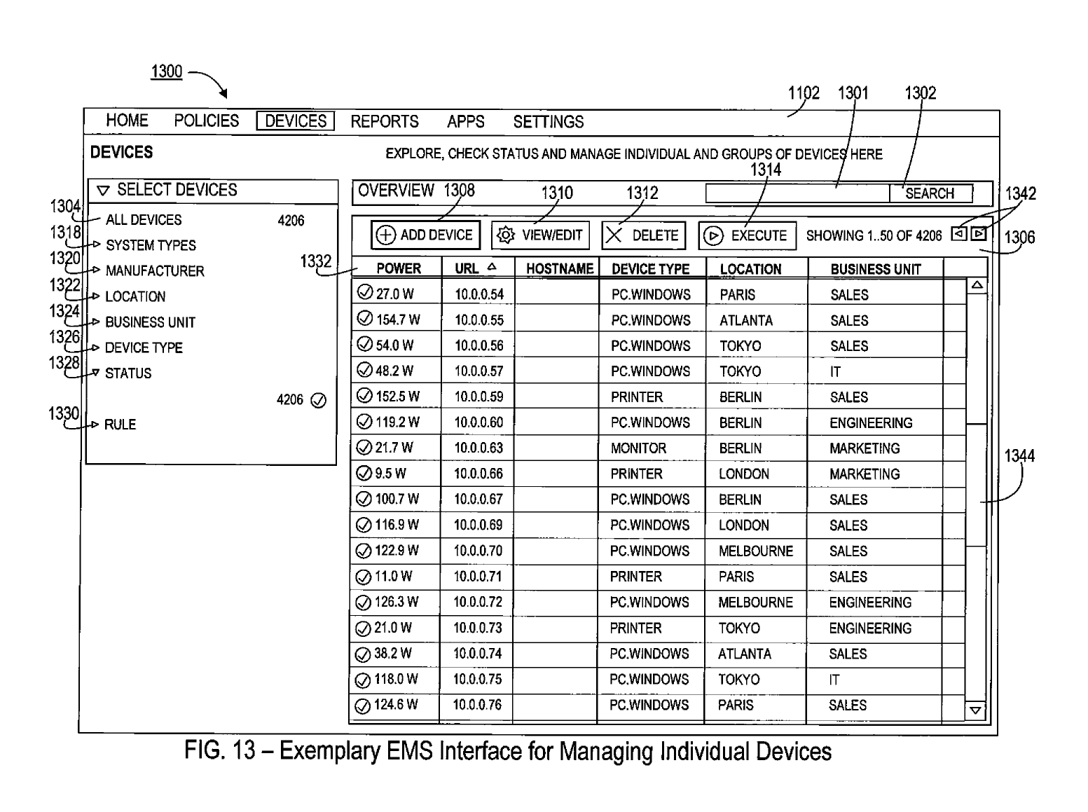

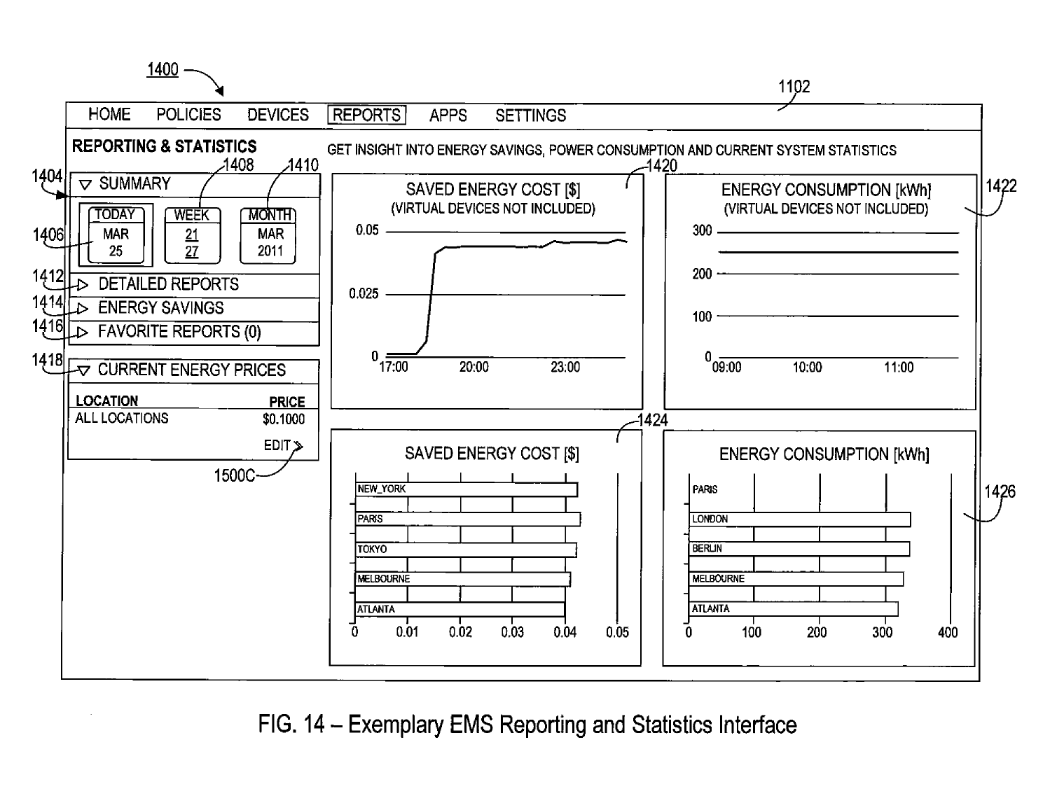

Exemplary screenshots of various embodiments of an EMS 110 interface are illustrated in FIGS. 11A-15D. In particular, FIG. 11A, FIG. 11B, FIG. 13 and FIG. 14 illustrate exemplary screenshots displaying reports of power consumed by various types of assets in multiple business units at different geographical locations. Thus, an EMS administrator can obtain reports containing power consumed by various assets according to asset type, date/time, location, region, department, business unit, region, etc. Additionally, reports can also provide analytics extracted from power-related information of assets involving savings in energy, savings in financial costs, carbon emissions and the like. As will be understood and appreciated by one skilled in the art, various other reports can be obtained and can even be customized to suit the requirements of an individual or an organization that intends to make use of such reports. These reports are utilized by individuals and organizations in making informed choices for planning and optimization of resources.

Furthermore, a screenshot showing interface settings/options for integrating assets (initially during setup) with the EMS 110 is indicated in FIG. 15A. Screenshots showing additional exemplary interface settings/options for an embodiment of the EMS 110 are illustrated in FIGS. 15B-15D. The screenshots shown in FIGS. 11A-15D are for the purposes of illustration only. As will be understood and appreciated, various widgets and tools can be added to a user interface of the EMS 110, depending on the choice of reports or display of information as desired by a person reviewing such an interface.

The materials discussed above in association with FIG. 1 merely provide an overview of an embodiment of the present system for energy efficiency management, and are not intended to limit in any way the scope of the present disclosure. Accordingly, further embodiments of the systems and methods and more detailed discussions thereof is provided below and in the accompanying figures.

### Exemplary Embodiments

Generally, one form of the present disclosure describes a system for monitoring, managing, controlling, and analyzing energy consumption of a collection of assets that are housed in different facilities. Turning to FIG. 2, an exemplary EMS architecture 200 is shown, including a detailed view of connections involving assets 104 and asset management systems 202 in a facility 102, along with architectural details of the EMS management module 114, which includes various software modules and components. In the embodiment shown in FIG. 2, a facility 102 houses various assets 104 such as desktops, laptops, HVAC equipment, lighting equipment etc. Generally, a collection of similar assets in a facility are grouped together and connected to an asset management system 202 corresponding to that type or group of assets. For example, desktops, laptops, printers are connected to asset management system 202A, which may relate to personal computing devices. Similarly, assets such as routers and VoIP phones are connected to another asset management system 202B. And, assets such as HVAC systems and lighting equipment may be connected to yet another asset management system 202C.

Generally, individual assets 104 as well as asset management systems 202 are also connected to an IT infrastructure 106 at facility 102. As recited previously, asset management systems may include elements of software and hardware that manage information relating to assets or devices operating in a facility. As will be understood and appreciated, assets listed in FIG. 2 are for the purposes of illustration only. Various other asset types from a wide variety of vendors and manufacturers can be used in a facility.

Still referring to FIG. 2, IT infrastructure 106 is connected to an embodiment of the EMS 110 via a network 108. As previously recited, the EMS 110 monitors, analyzes, and controls individual assets 104 at a facility or facilities. As further shown in FIG. 2, the EMS 110 includes an EMS management module 114 and EMS database 112. The EMS management module 114 further comprises device proxies 204 for communicating with individual assets in the facility 102, and asset connectors 206 to enable communication with the asset management systems for retrieval of data relating to the assets. The embodiment of the EMS management module shown in FIG. 2 further comprises an EMS engine 216 that includes various sub-modules including an implementation engine 208, device monitoring engine 210, policy engine 212 and reporting engine 214. These engines and modules generally comprise software algorithms for carrying out specific EMS functionalities, as described in greater detail below.

Generally, asset connectors 206 are connected with network 108 in order to discover and import assets 104 into the EMS 110, with the help of asset management systems 202. When provided with identifying attributes such as a network address and hostname, an asset connector opens a remote connection with one or more asset management systems in order to communicate with assets. For instance, the EMS 110 may use asset connector 206A to import all WINDOWNS™ computers from an asset management system like Active Directory. In another example, asset connector 206B is used to automatically discover monitors and printers housed in a facility. Further, in another example, an asset connector is used to import VoIP phones from another asset management system such as CISCO™ Call Manager, and so on. Generally speaking, asset connectors 206 integrate with asset management systems in order to extract preexisting information relating to individual assets 104 for purposes of inventory management of assets in a facility. Arbitrary configuration settings for importing exemplary assets are shown in an exemplary screenshot in FIG. 15A.

As will be understood by a person skilled in the art, in many situations, some assets are not IP enabled, or assets may be unique to some organizations. For example, lighting equipment or specific mechanical machinery in a factory might not have the ability to connect to a network. In such situations, an asset connector can be combined with data sources like SAP to retrieve information from such assets, using database connectors (like ODBC, or Comma Separated File for example), for importing such assets into an embodiment of the EMS 110.

As will be understood, asset management systems provide information (about assets) in the form of various attributes, for example, IP addresses of assets, hostnames of assets, locations, business units, etc. In many situations, asset management systems are not configured to group assets based on specific attributes. For example, in many organizations, Active Directory is not configured to organize assets according to location or business unit of assets. In such situations, asset connectors can be used to assign locations and business units to assets. Furthermore, in another example, asset connectors can be used to assign various assets in an organizational hierarchy into subnets or subdomains of an IP network. As will be understood and appreciated, this methodology of abstracting assets with a standard set of attributes provides a way of importing and further classifying various assets into an embodiment of the EMS.

As can be further understood by a person skilled in the art, several asset connectors can retrieve information about a given asset. For example, in one embodiment, the implementation engine 208 performs the task of configuring the EMS 110 and initiating retrieval of information (specifically, various attributes, as explained previously) from assets (or, from asset management systems) using asset connectors 206. Information retrieved from several asset connectors is merged by implementation engine 208 into a single profile for an asset (a “device profile”) in the EMS in order to limit multiple copies of identical information retrieved from several asset connectors. This “merging” of information can be accomplished according to predefined hierarchies or ranks determined by an EMS user, or according to other predefined protocols. Details of steps performed by the implementation engine 208 are described below in connection with an exemplary flowchart in FIG. 5A and FIG. 5B.

Still referring to FIG. 2, according to one embodiment, device proxies 204 work hand-in-hand with asset connectors 204 to implement low-level communication protocols with existing assets 104. Device proxies generally comprise predetermined algorithms that enable communication with a particular type of device. For instance, in the example architecture 200 shown in FIG. 2, assume device proxy 204A supports an industry protocol such as WINDOWS™ Management Instrumentation (WMI) to communicate with WINDOWS™ machines, device proxy 204B supports Secure Shell (SSH) for LINUX™ and APPLE™ machines, device proxy 204C supports Simple Network Management Protocol (SNMP) for networking equipment like switches and routers and many more such protocols. Multiple device proxies exist because embodiments of the EMS 110 communicates with a wide variety of assets on different platforms and operating systems. According to one embodiment of the present disclosure, the EMS 110 communicates with individual assets using device proxies associated with such assets, for purposes of monitoring and control of individual assets 104. According to another embodiment of the present disclosure, for purposes of monitoring and control, the EMS 110 communicates with individual assets using a combination of associated device proxies, and associated asset connectors for such assets. In this second embodiment, generally, the device proxy communicates with an asset connector, that in turn communicates with an asset management system, that yet in turn communicates directly with the device. It is the use of these device proxies and asset connectors that enables normalized and standardized information retrieval, storage, and monitoring within an EMS by a system user.

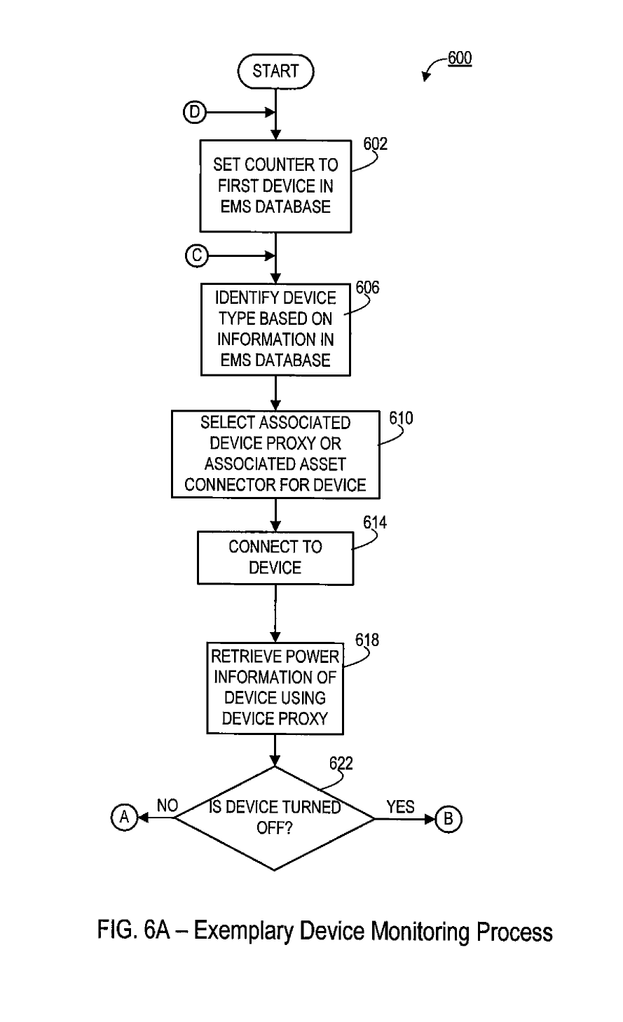

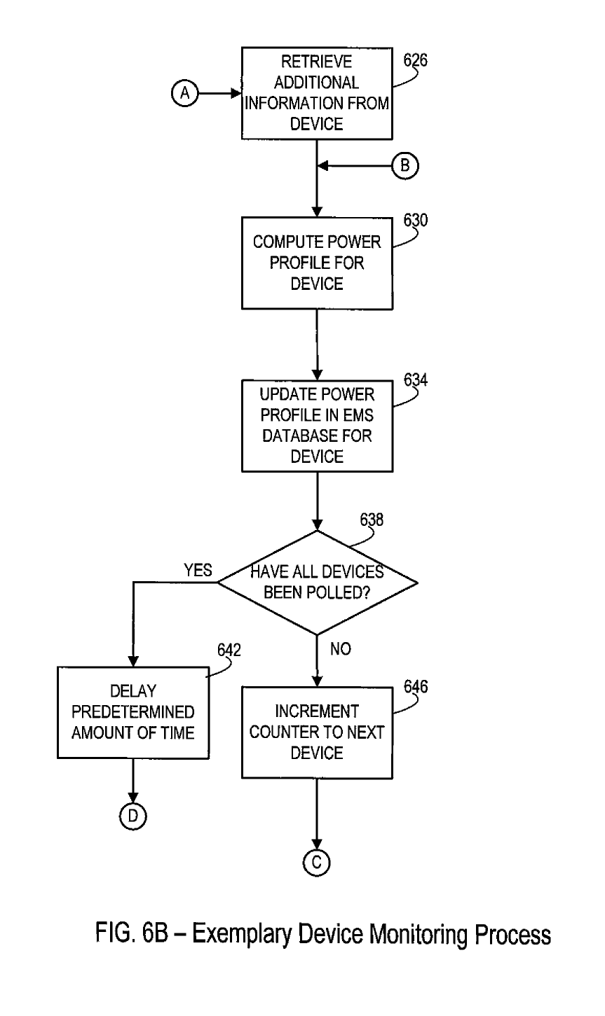

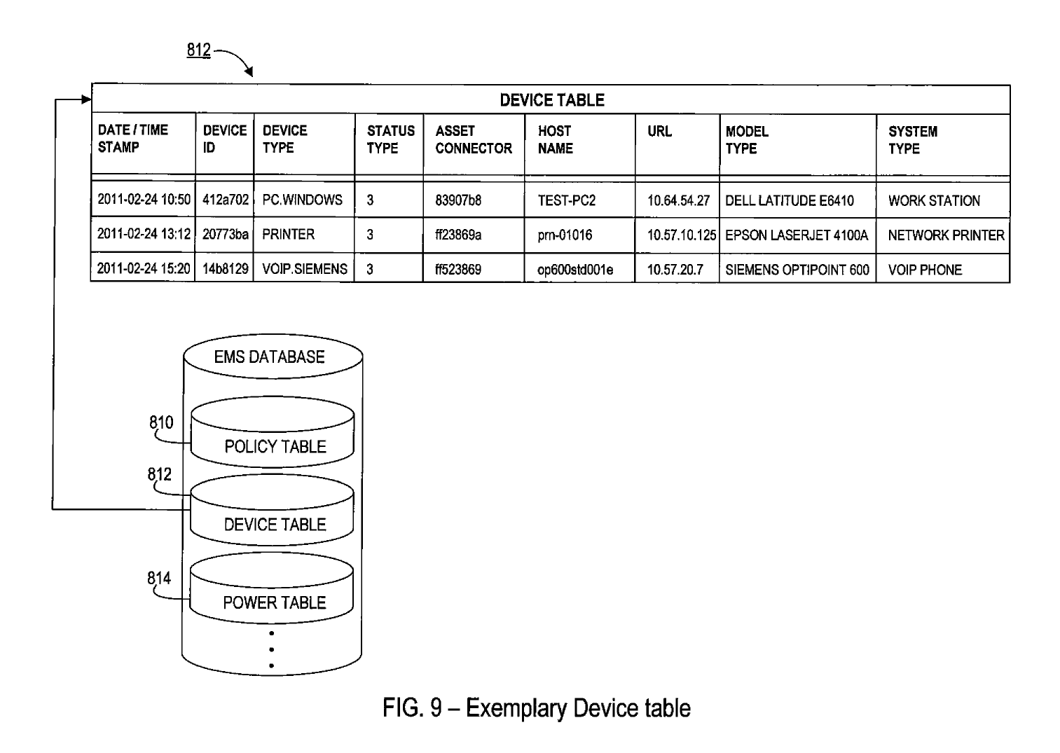

Still referring to the modules maintained within the EMS engine 216, an embodiment of the device monitoring engine 210 performs the task of monitoring energy information and other information of individual assets 104. Monitoring generally involves periodic polling of assets for their power status (for example, on/off/hibernate), power consumption, load and utilization, hardware and software configuration changes, or even to changes of attached assets (for example, if a monitor is disconnected from a computer, and various such changes). Power consumption data, along with other information collected from assets via the device monitoring engine 210 is stored in the EMS database 112 for subsequent processing. Exemplary data and columns storing such data is shown in database tables in FIG. 9. Details of steps performed by an embodiment of the device monitoring engine 210 are described in connection with an exemplary flowchart in FIG. 6A and FIG. 6B.

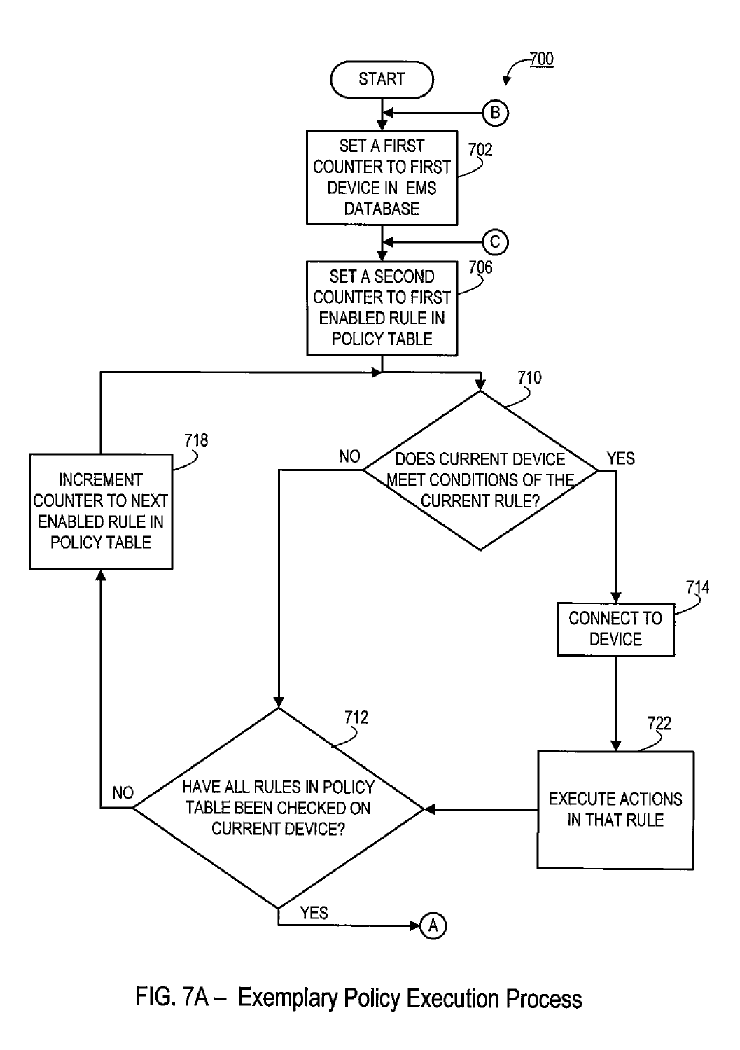

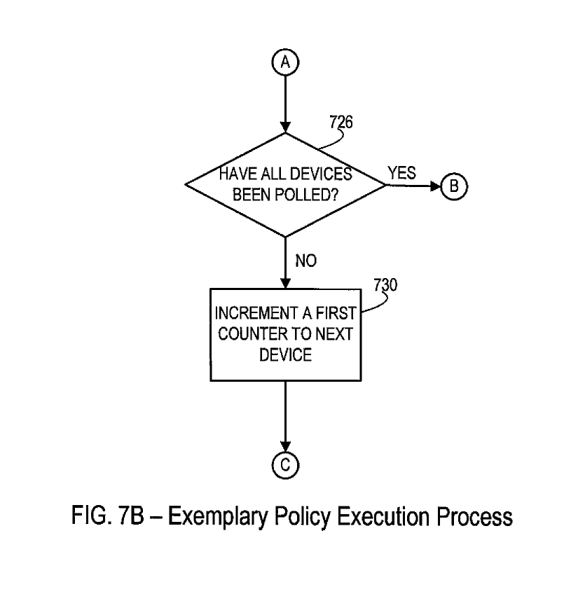

Further, as described in greater detail below, control of assets includes various measures to save energy by dynamically powering off or reducing energy consumption of devices. According to one embodiment, these measures are crafted and implemented via a policy engine 212 that provides a flexible framework to create sophisticated power management rules. Such rules are received by the EMS 110, either during initialization of the EMS 110, or during normal operation, and stored in the EMS database 112. Exemplary rules are illustrated in FIG. 8. Details of steps involved in executing such rules on various assets is described in FIG. 7A and FIG. 7B.

Still referring to FIG. 2, data collected from assets, both in real time as well as non-real time, is used for extensive reporting on energy consumption, energy savings, carbon emissions and various other such attributes. In the embodiment shown in FIG. 2, the reporting engine 214 provides various reports involving various statistics and analytics extracted from collected data. Further, reports can also be customized to suit the requirements of an individual or an organization who wishes to review such reports.

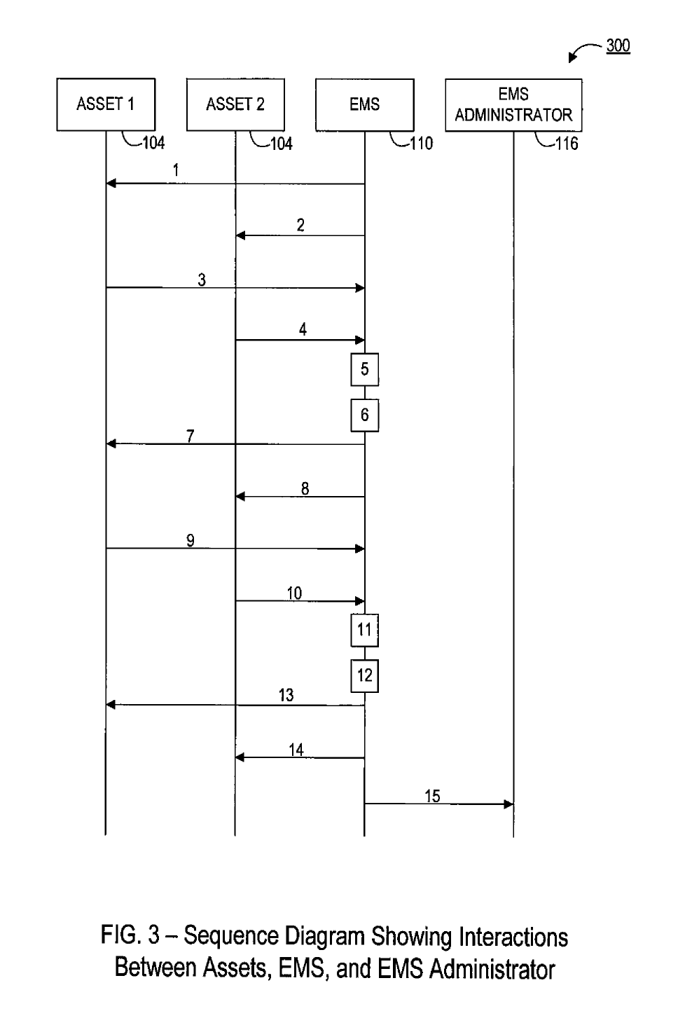

FIG. 3 is an exemplary sequence diagram illustrating the steps involved in the interactions between various components of an embodiment of the present system, for purposes of energy efficiency management of assets housed in a facility, according to an exemplary embodiment of the present system. As explained in greater detail below, the components of the system are involved in various aspects of energy efficiency management involving monitoring, analysis, control, data collection, and display/reporting of power consumption related information of assets in a facility.

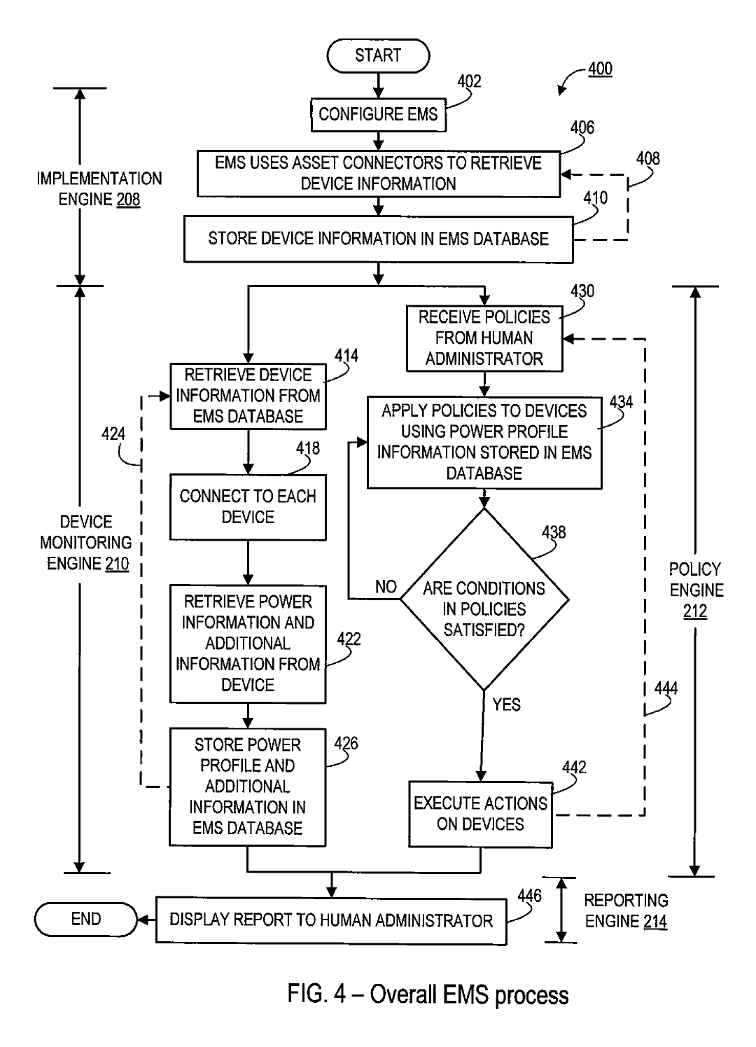

Starting at step 1 in FIG. 3, during an initial configuration phase, the EMS management module 114 (specifically, the implementation engine 208) polls an Asset 1 using asset connectors and asset management systems over an IP network to retrieve device information relating to Asset 1. Details of steps performed by an embodiment of the implementation engine are explained with flowcharts in FIGS. 4, 5A and 5B. Similarly, during another initial configuration phase at step 2, an Asset 2 is polled by the EMS management module 114. As recited previously, Asset 1 and Asset 2 are connected to asset management systems at a facility, and the EMS management module 114 uses asset connectors to poll Asset 1 and Asset 2. At steps 3 and 4, information from both assets is retrieved by asset management systems connected to these assets and transferred over a network to the EMS 110. In one embodiment of the present disclosure, retrieved information includes (but is not limited to) network address (URI/URL) of the assets, hostnames of assets, locations, business units, etc. As will be understood and appreciated, embodiments of the present disclosure are not limited to the energy efficiency management of two (2) assets. Embodiments of the present disclosure are applicable on any number of assets, comprising a variety of asset types, brands, vendors and manufacturers, and the simplistic view of two assets shown in FIG. 3 is provided for illustrative purposes only.

At step 5, the EMS management module 114 (specifically, the implementation engine 208) stores (saves) retrieved asset information (related to both assets in this example) in the EMS database 112 to enable subsequent monitoring and control by various software modules, as explained below. An exemplary datatable showing asset information stored in the EMS database is shown in FIG. 9. At step 6, the EMS management module 114 (specifically, the device monitoring engine 210) retrieves asset information from the EMS database 112. This information is used to locate/identify (using various attributes like IP address, hostname, etc.) individual assets and connect to them with the help of asset connectors and/or device proxies. Thus, at following steps 7 and 8, the EMS management module 114 connects to Asset 1 and Asset 2 with the help of asset connectors and/or device proxies, as necessary. Next, at steps 9 and 10, information relating to energy usage or consumption of Asset 1 and Asset 2 is retrieved from Asset 1 and Asset 2 by the EMS management module 114 (specifically, the device monitoring engine 210) and stored in a respective power profile for each respective device. Summary snapshots of power profile information as in exemplary reports to an EMS administrator are shown in FIGS. 11A, 11B, 13 and 14.

In addition to power profile information, embodiments of the EMS management module 114 also collect other types of information from assets. Examples of additional information include the hardware configurations of assets, additional devices connected to assets like printers, monitors, scanners, audio speakers, current load/utilization information of respective asset, operational temperatures of assets, etc. After such information is obtained from the assets, the EMS management module 114 saves or updates the device profile and/or power profile corresponding to the newly-identified information, at step 11. As will be understood, this information may be utilized by an embodiment of the policy engine 212 to execute various energy management policies for various devices. As described above, these policies are generally created by a system user within the EMS 110 during initialization, or during normal operation, and stored in the EMS database 112 for subsequent use.

Still referring to FIG. 3, at step 12, the EMS management module 114 (specifically, an embodiment of the policy engine 212) retrieves energy management policies, power profile information, device profile information, and additional information (if any) that has been saved earlier. According to one embodiment of the present disclosure, these energy management policies were created by a (human) EMS administrator 116 and saved in the EMS database 112. An exemplary datatable saved in the EMS database 112 including exemplary policies is shown in FIG. 8. Screenshots of exemplary policies are provided in FIGS. 12A-12C, and FIG. 15B. Policies for performing energy efficiency management of assets govern how and when assets are to be turned off/on in order to achieve energy efficiency. These rules are communicated to asset management systems (connected to individual assets) for executing on individual assets. For example, a policy could indicate turning off assets in a certain facility at 7 pm and turning them on at 6 am.

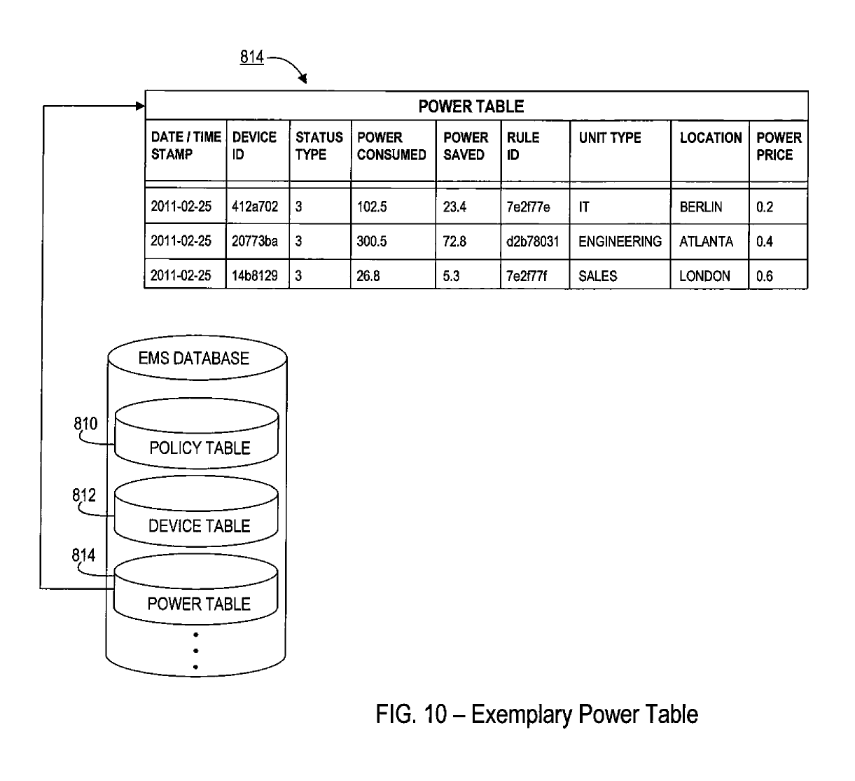

At steps 13 and 14, respectively, the EMS management module 114 connects to individual assets located at facilities, using asset connectors and/or device proxies maintained within the EMS, and applies/executes energy management policies on respective assets. Finally, at step 15, the EMS displays energy management reports of assets to an EMS administrator 116. A datatable showing exemplary report saved in the EMS database 112 is shown in FIG. 10. Exemplary reports are illustrated in FIGS. 11A, 11B, 13 and 14. As will be understood and appreciated, embodiments of the present disclosure are not limited to the specific processes or sequences for energy efficiency management as discussed in FIG. 3, and other embodiments may implement other processes as will occur to one of ordinary skill in the art. Further, embodiments of the present disclosure are applicable on any number of assets, comprising a variety of asset types, brands, vendors and manufacturers.

Turning now to FIG. 4, a flowchart representing a high-level process 400 of energy efficiency management performed by various modules and software components that comprise an embodiment of the EMS is shown. Details of steps performed by individual software components are explained in FIGS. 5A-7B. As will be understood and appreciated, the steps of the process 400 shown in FIG. 4 are not necessarily completed in the order shown, and various processes of the EMS may operate concurrently and continuously. Accordingly, the steps shown in FIG. 4 are generally asynchronous and independent, computer-implemented, tied to particular machines (including various modules/engines of the EMS management module 114, EMS servers, and end devices), and not necessarily performed in the order shown.

Starting at step 402, the EMS 110 (specifically, the implementation engine 208) is configured by retrieving asset information from various assets and storing the retrieved information in the EMS database 112 using asset management systems and asset connectors. As recited previously, during this configuration phase, asset information retrieved may comprise various attributes related to asset type, model number, manufacturer, network name/address associated with device, and the like. At step 410, retrieved asset information is stored in the EMS database 112. As can be seen from FIG. 4, in one embodiment, steps 402, 406 and 410 are performed by an implementation engine 208 in a repetitive and iterative fashion (indicated with dotted line 408). In other words, asset information is periodically synchronized/updated in order to ensure all device data is up-to-date. Details of steps performed by the implementation engine are explained with a flowchart in FIGS. 5A and 5B.

Continuing with FIG. 4, it can be further seen that a sequence of next steps executed within the EMS are performed by an embodiment of the device monitoring engine 210 and policy engine 212 concurrently. Generally, the steps performed by the policy engine 212 include applying/executing policies for energy efficiency management of individual assets, whereas, steps performed by the device monitoring engine 210 are executed primarily for purposes of monitoring power consumption of individual assets. Thus, it can be understood that, in one embodiment, the steps performed by the device monitoring engine 210 and policy engine 212 occur in parallel and may be dependent upon each other. For the sake of explanation in this document, steps performed by the device monitoring engine 210 (comprising steps 414, 418, 422, and 426, and shown as the left sub-branch of the flowchart 400) are explained first, and then the steps performed by the policy engine 212 (comprising steps 430, 434, 438 and 442, and shown as the right sub-branch of the flowchart) are explained thereafter.

At step 414, the EMS (via the device monitoring engine 210) retrieves asset information stored in the EMS database 112. Retrieved asset information is generally used to connect (at step 418) to individual assets, for the purposes of monitoring individual assets. According to one embodiment of the present disclosure, device proxies are used to connect to individual assets. As describe above, a device proxy generally comprises a communication algorithm that is specific to a particular device type to enable communications with a given device. According to another embodiment of the present disclosure, both asset connectors and device proxies are used to connect to individual assets. In embodiments in which both device proxies and asset connectors are used, asset management systems connected to such assets provide power profile information of respective assets. As mentioned above, examples of power profile information include (but are not limited to) real-time power consumption of the device, duration of time for which device has been operational, etc.

At step 422, current energy information or power profile information (and potentially other information relative to the device) is retrieved by the device monitoring engine 210. As mentioned above, examples of additional information include information relating to peripheral devices (monitors, printers, etc.) connected to the assets, hardware configurations of the assets, etc. Generally, power profile information and additional information retrieved from assets is stored in the EMS database 114 at step 426. As recited previously, the device monitoring engine 210 periodically monitors assets in order to keep up-to-date information of assets in the EMS database 112, and thus reverts back to step 414 periodically (indicated with dotted line 428). In one embodiment, this periodic execution of the device monitoring process may be executed every few seconds, or minutes, or hours, etc., depending upon the desires of a system user or administrator. Details of steps performed by the device monitoring engine 210 are explained with the help of a flowchart in FIG. 6A and FIG. 6B.

Described next is a high-level summary of steps performed by an embodiment of the policy engine 212 for executing energy management policies, in parallel with the device monitoring engine 210. At step 430, policy engine 212 receives policies for performing energy efficiency management. According to one embodiment of the present disclosure, such policies are generated or created by an EMS administrator 116 or user through a policy-creation interface (not shown) and pre-stored in the EMS database 114. (Exemplary policies are shown in FIG. 8, and FIGS. 12A-12C.) At next step 434, the policy engine 212 applies policies for performing energy efficiency management of assets, using associated power profile information and/or device profile information stored in the EMS database 114. Policies or rules for performing energy efficiency management of assets govern various aspects of the energy state or power state of a device, including how and when assets are to be turned off/on in order to achieve energy efficiency. Various other embodiments of rules relate to other actions to be taken with respect to devices, including providing information relating to the device to a system user, or storing certain information automatically in a database, or providing an alert to a system user, etc. These rules are processed by the EMS and actions associated with rules are communicated with the help of asset connectors and/or device proxies in order to be executed on the individual assets/device in step 442.

A policy (or synonymously, a rule) is comprised of one or more associated conditions and actions. Generally, rules include directions to conduct one or more specific actions on one or more assets depending on satisfactions of one or more conditions. Generally, conditions are criteria that are required to be satisfied to enable actions for energy efficiency management to be executed with respect to assets. For example, in an exemplary rule that dictates turning off assets in an Atlanta office at 7 pm and turning them on at 6 am on weekdays, the action involved is turning off and turning on assets. The set of conditions comprises (a) dates and times, i.e., every weekday 7 pm, every weekday 6 am, and (b) location, i.e., an Atlanta office; at which actions (turning off and turning on take place) are executed.

Still referring to FIG. 4, at step 438, the policy engine verifies that the set of conditions in a give rule have been satisfied. In the above example, all assets in Atlanta office satisfy these conditions and hence are turned off on weekdays at 7 pm, and turned back on at 6 am. If the assets do not satisfy the conditions, the policy engine 212 proceeds to process the next rule by reverting back to step 434, until all rules have been processed. According to one embodiment, one or more rules are generated within and/or provided to the EMS 110 either during initialization of the EMS 110, or during normal operations of the EMS. These rules are generally stored in a policy table in the EMS database 112. An exemplary policy table is shown in FIG. 8.

If the conditions of a given rule have been satisfied, then action(s) associated with that rule are executed (at step 442) with respect to aspects that are encompassed by the rule. As recited previously, policy engine 212 periodically synchronizes with assets for the purposes of applying rules vis-à-vis controlling individual assets, and thus reverts back to step 434 periodically (indicated with dotted line 444 in FIG. 4).

Finally, it can be seen from FIG. 4 that resultant effects of monitoring and control of assets are displayed in the form of reports at step 446, by (in one embodiment) reporting engine 214. According to one embodiment of the present disclosure, the EMS generates various reports and analytical tools relating to device profile information and power profile information, and a system user reviews the energy efficiency management reports through a graphical-user-interface, along with detailed analytics related to power consumption and cost savings. Exemplary screenshots showing various reports are indicated in FIGS. 11A, 11B, FIG. 13 and FIG. 14.

Now referring to FIG. 5A and FIG. 5B, a flowchart 500 showing computer-implemented method steps involved in configuring an EMS at one or more facilities is described. Starting at step 504, an embodiment of the implementation engine 208 retrieves a list of asset connectors from within the EMS. As can be seen in FIG. 2, in use, asset connectors are connected with a network in order to discover and import information relating to assets into the EMS 110, with the help of asset management systems 202. As will be described later, given identifying attributes like a network address and hostname, an asset connector opens a remote connection with an asset management system in order to communicate with assets. Generally, asset connectors comprises predetermined algorithms that are specific to a given device type or other predefined criteria, and enable communication with specific, predetermined types of assets. For instance, the EMS may us asset connector 206A to import all WINDOWS™ computers from an asset management system like Active Directory. In another example, asset connector 206B are used to automatically discover monitors and printers housed in a facility, and so on.

As will be understood by a person skilled in the art, in many situations, some assets are not IP enabled, or assets may be unique to some organizations. For example, lighting equipment or specific mechanical machinery in a factory might not have the ability to connect to a network. In such situations, an asset connector can be combined with data sources like SAP to retrieve information from such assets, using database connectors (like ODBC, or Comma Separated File for example), for importing such assets into EMS 110.

At step 508, a counter is initialized to a first asset connector in a list of asset connectors. Then, at step 512, the EMS remotely connects to an asset management system associated with said asset connector. After connection is established, the EMS (e.g., via the implementation engine 208) retrieves (at step 516) a list of assets connected with respective asset management system. For example, an asset connector is used to communicate with an asset management system like Active Directory to retrieve/import all WINDOWS™ computers into the EMS 110. After retrieval of list of assets, at step 518, the EMS initializes a counter to point to a first device in that list. Next, at step 520, the EMS retrieves device information for said device from an asset management system. As will be understood, asset management systems provide information (about assets) in the form of various attributes, for example, IP address of assets, hostname of assets, location, business unit, etc. Exemplary attributes (indicated in columns) along with representative device data are shown in FIG. 9.

In many situations, asset management systems are not configured to group assets based on specific attributes. For example, in many organizations, Active Directory (an asset management associated with WINDOWS™ computers) is not configured to organize assets according to the location or business unit of the assets. In such situations, asset connectors can be used to assign locations and business units to assets. Furthermore, in another example, asset connectors can be used to assign various assets in an organizational hierarchy into subnets or subdomains of an IP network. As will be understood and appreciated, this methodology of abstracting assets with a standard set of attributes provides a way of importing and further classifying various assets in EMS, and further enables normalized monitoring and control of assets.

In one embodiment, several asset connectors are used to import assets and communicate with asset management systems. Generally, asset connectors are configured to communicate with particular asset management systems, and will include communication protocols and criteria corresponding to the particular asset management systems. According to one embodiment of the present disclosure, assets are imported by an EMS administrator through an interface, by using one or more asset connectors. An exemplary screenshot showing exemplary asset connectors as displayed through an interface to an EMS administrator for importing assets into the EMS 110 is shown in FIG. 15A. According to another embodiment, a scripting language (for example, JavaScript) can be used to import assets into an EMS 110, using several asset connectors. In one embodiment, information retrieved from several asset connectors is merged by the EMS into a single device profile for an asset in order to limit multiple copies of identical information retrieved from several asset connectors, and in order to consolidate and aggregate all available asset information.

Referring to FIG. 5B, at step 524, the EMS verifies if a device profile (retrieved at step 520) corresponding to a given asset already exists in the EMS database 112. As will be understood and appreciated, a device profile generally comprises a collection of data stored within an embodiment of the EMS relating to the characteristics of a given device. If device profile does not exist in the EMS database 112 for the given device, then a new entry for said device is first created at step 528. If, however, a device profile already exists for the given device, or after a new entry for the device is created, the device profile is updated (at step 532) based on the device information retrieved at step 520. After the device profile has been updated, the EMS (via the implementation engine 208) verifies (at step 536) that all devices (in list of devices obtained from asset management system at step 516) have been polled. In case all devices have been polled, the EMS moves on to a next asset connector (in list of asset connectors collected at step 504) by incrementing (at step 540) a counter to point to the next asset connector, and reverts back to step 512. Alternatively, if at step 536, the EMS determines that all devices have not been polled, then the EMS moves to the next device in list of devices, and thus reverts back to step 520.

As recited previously in FIG. 4, embodiments of the EMS periodically synchronize with assets in order to retrieve device information, and update the corresponding device profiles. In other words, the steps of the process explained in FIG. 5 are generally performed at periodic intervals of time. This ensures that the device profile stored in the EMS database 112 is current and up-to-date for purposes of monitoring power consumption (as performed by an embodiment of the device monitoring engine 210 and explained in FIGS. 6A and 6B) and execution of energy efficiency management policies (as performed by a policy engine and explained in FIGS. 7A and 7B).

Now referring to FIGS. 6A and 6B, a flowchart illustrating computer-implemented steps performed in monitoring power consumed by individual assets is described. According to one embodiment, the steps shown in FIG. 6 are performed by a device monitoring engine 210 maintained within an embodiment of the EMS. Starting at step 602, the EMS initializes a counter to point to a first device in a list of devices that are to be monitored. (As will be understood, list of devices that are to be monitored have their device profile information pre-stored in the EMS database 112, as explained in FIG. 5). At next step 606, based on information stored in the device profile, an asset type is identified for a given asset. At next step 610, a device proxy associated with the asset is selected by the EMS. In other words, the EMS maps an asset type to an associated device proxy. Generally, device proxies are predetermined algorithms that enable communications with individual devices based on the device type or other device attributes. For instance, if a device profile indicates an asset is a WINDOWS™ computer, then a device proxy supporting Windows Management Instrumentation (WMI) associated with WINDOWS™ computers is selected for communication.

Next, at step 614, the EMS connects to asset to enable information retrieval from the asset. According to one embodiment of the present disclosure, the EMS connects with individual assets using device proxies associated with such assets. According to another embodiment of the present disclosure, the EMS connects with individual assets using a combination of associated device proxies, and associated asset connectors for such assets. In this second embodiment, the asset connector communicates with an asset management system associated with a facility to enable information retrieval from the device. As will be understood, other communication mechanisms can be used as will occur to one of ordinary skill in the art.

After a connection is established with an asset, various attributes related to power or energy information is retrieved for a respective asset, at step 618. Examples of different attributes of power information include real-time power consumption of device, duration of time for which device has been operational, power state of device (on/off/hibernate modes), and various other such power-related details. Power information retrieved from asset is utilized by the EMS to determine whether asset is turned off or on, or is in some other power state. In one embodiment, if the asset is not turned off, additional information is retrieved from asset (step 626). In addition to power information, the EMS also collects additional information from assets, such as hardware configurations of assets, additional devices connected to assets like printers, monitors, scanners, audio speakers, etc., current load/utilization information of a respective asset, operational temperature of an asset, etc. After such information is obtained from assets that are turned on, or, in case, an asset is turned off, the EMS computes a power profile for the asset at step 630 to arrive at a value for power consumed by an asset (either currently or over a predetermined time period). Generally, a power profile is a collection of information relating to power attributes of a given device at a certain time (or over a period of time), and the power profile is stored in a database for subsequent processing and use.

According to one embodiment of the present system, a value for power consumed by an asset includes actually measuring power consumed by an asset in real-time, by sensors that are pre-installed on an asset. For example, manufacturers of computing devices like computers and servers often pre-install on-board sensors that measure total power consumed by such devices. Hence, assets which have sensors to measure power can provide the EMS with a direct measurement of power consumed by such assets.

According to another embodiment of the present system, a pre-existing proprietary software algorithm is used to estimate power consumed by assets, determined by power consumed by various physical hardware components of an asset. Examples of such hardware components may include: a type of processor, type of graphic card, and various other such components. As will be understood by one skilled in the art, various hardware components measure their respective power consumption. According to one embodiment, a software algorithm is designed to arrive at a low estimate and a high estimate of the power consumed by an asset, using measured values of power reported by various hardware components within the asset. High and low estimates of power consumed by various hardware components are further used along with current load/utilization values of a respective asset, to arrive at an actual estimate of power consumed by the respective asset.

According to yet another embodiment of the present disclosure, typical or average values of power consumed by various types of assets at given loads, energy states, or utilizations are pre-stored in an EMS database 112 or in a “cloud” database. Thus, given a particular energy state of a given asset (e.g., on, off, or hibernate mode), an estimated value of power consumed by that assets can be obtained using a database lookup.

At next step 634, the EMS saves or updates the power profile of the given asset based on the retrieved and/or calculated power information in the EMS database 112. As will be described in greater detail below, this information is utilized by a policy engine 212 to execute various energy management policies, as explained with a flowchart in FIGS. 7A and 7B. At step 638, the EMS verifies whether or not all devices (with pre-stored device profile in the EMS database 112) that are to be monitored have been polled. In case all devices have not been polled, the EMS moves on to a next device by incrementing (at step 646) counter to point to next device, and reverts back to step 606.

In case all devices have been polled, the EMS delays a pre-determined interval of time, and then reverts back to step 602. According to one embodiment of the present disclosure, this pre-determined interval of time can be set by an EMS administrator through an interactive user interface. As will be understood, this predetermined interval of time could be virtually continuous (polling every few seconds or less), or could be longer (once every hour or few hours) depending upon the system capabilities of the given EMS and the desires of the system user. An exemplary screenshot showing settings for adjusting the pre-determined interval of time is shown in FIG. 15D. According to another embodiment of the present disclosure, a scripting language (like JavaScript) can be used to set or adjust the pre-determined interval of time for performing monitoring of power consumed by assets. As recited previously, the EMS performs periodic monitoring of devices in order to ensure that power consumption information of assets is up-to-date in the EMS database 112.

Turning now to FIGS. 7A and 7B, a flowchart is shown that describes a computer-implemented method of executing various policies for energy efficiency management of assets. According to one embodiment, the processes and steps 700 shown in FIG. 7 are carried out by a policy engine 212 within an embodiment of the EMS. As recited previously, policies comprise rules (directions) that incorporate conditions that govern, for example, how, where and when assets are to be controlled (e.g., turned off), or govern certain actions to be taken with respect to assets. According to one embodiment of the present disclosure, policies are created by an EMS administrator, through an interactive graphical user interface (GUI) provided by the EMS. According to another embodiment, a scripting language (for example, JavaScript) can be used to specify rules for energy efficiency management. One or more policies are received by the EMS and executed on assets, as indicated in the policy.

As recited previously, a policy/rule is an abstract collection of conditions and actions. In one embodiment, rules are directions to conduct one or more specific actions on one or more assets depending on satisfaction of a set of conditions. Conditions are criteria that are required to be satisfied so that actions for energy efficiency management can be executed on assets. For example, in an exemplary rule that states turning off assets in Atlanta office at 7 pm and turning them on at 6 am, the action involved is turning off and turning on assets. The set of conditions comprise of (a) dates and times, i.e., every weekday 7 pm, every weekday 6 am, and (b) location, i.e., Atlanta office; at which actions (turning off and turning on take place) are executed.

Moreover, it can be observed that in this exemplary policy recited immediately above, a terminating condition is not specified, i.e., when said policy will cease to be executed. As a result, in one embodiment, such a policy will continue to be executed until it is terminated by an EMS administrator. As will be understood, more than one policy for performing energy efficiency management can be executed on a given asset or group of assets. According to one embodiment of the present disclosure, multiple policies can be ordered according to a predetermined sequence so that one policy has higher priority over other policies. In such a case, a policy that has a higher priority will first execute its associated actions for energy efficiency management, before a policy that has a lower priority. As will be understood and appreciated, the priority or hierarchy of policies may be dictated by an EMS user, or EMS administrator, or preconfigured within the EMS, etc. As will be further understood by a person skilled in the art, this ranking mechanism could automatically render a policy that has a lower priority as being inoperative. This is better illustrated with an example: assume a higher priority policy indicates “Turning off all assets in a Sales department for one week”, and a lower priority policy indicates “Hibernating all assets between 12 noon and 1 pm.” Because all assets have been turned off, based on the higher priority policy, the lower priority policy is rendered inoperative automatically. This, and various other aspects of the process of executing energy efficiency management policies will be better understood with the help of process 700 as discussed below.

Still referring to FIG. 7A, starting at step 702, the EMS initializes a first counter to a first device in a list of devices that are to be managed/controlled. As previously mentioned in relation to FIGS. 5 and 6, in one embodiment, devices that are to be managed and/or controlled have their device profile information and power profile information pre-stored in the EMS database 112. As will be understood, a policy table (for example as shown in FIG. 8) contains several energy management rules for execution on assets. In one embodiment, the policies are ranked according to a predetermined sequence so that one rule has higher priority over other rules in the policy table. Thus, if two or more policies apply to a given asset simultaneously, the higher “ranked” (e.g., more important) policy is the one that will control and ultimately be implemented with respect to the asset. According to one embodiment of the present disclosure, a rule in a policy table can be disabled or enabled by a human EMS administrator. Enabling/disabling a rule causes a rule to be activated/deactivated. In other words, if a rule is disabled, it is not executed by the EMS 110, although it is specified in a policy table in the EMS database 112 for potential later use. Accordingly, at step 706, a second counter is initialized to point to a first enabled rule in a policy table. As mentioned previously, a rule is associated with one or more conditions that are to be satisfied for the rule to be executed. Generally, conditions are specified when a policy is created. Conditions typically depend on asset type, associated business unit, asset location, date/time when policies are to be executed, power state (on/off/hibernate etc.) of assets, power consumed by assets, software and programs running on assets, and several other such factors. (Exemplary policies (rules) and conditions are illustrated with a policy table in FIG. 8, and also with screenshots in FIGS. 11A, 11B.)

Hence at step 710, policy engine 212 determines whether a current asset satisfies conditions specified in a current rule. For example, a rule could indicate turning off assets in a certain facility at 7 pm and turning them on at 6 am. Another rule could indicate turning off all assets at a specific business unit for a certain number of days. Yet another rule could indicate turning off laptops and desktops that are not running a particular application, for example programs like MICROSOFT OFFICE™ or MICROSOFT POWERPONT™. Generally, whether or not a policy has been satisfied is determined by comparing information for a given asset maintained in its respective power profile and/or device profile to criteria (conditions) included in the given policy. If the conditions are satisfied based on information in the respective profiles, then the policy may be deemed satisfied (and the corresponding action may be executed).

As will be understood by a person of ordinary skill in the art, a given device may not satisfy conditions specified in a rule. For example, if an action associated with a rule comprises turning off assets in an Atlanta facility, then assets located in a New York facility, for example, will not satisfy this rule. However, it could be possible, for example, that another rule in a set of rules indicates hibernating all assets in North America. Accordingly, conditions in such a rule are satisfied by assets located in the Atlanta facility as well as assets located in the New York facility. Thus, in one embodiment, if a given device/asset does not satisfy conditions specified in a current rule, the policy engine 212 will check whether or not any other rule in a policy table is remaining to be checked for execution with respect to the current asset. In other words, at step 712, the EMS determines whether or not all rules in a policy table have been checked for execution with respect to a given device. As will be understood and appreciated, a policy table generally comprises one or more policies or rules.

If all rules have not been checked with respect to a given device, then a second counter is incremented (at step 718) to point to the next enabled rule in a policy table, and subsequently the process reverts back to step 710. If information associated with the current asset satisfies conditions specified in the current rule at step 710, the policy engine 212 provides instructions to said device (e.g., via a device proxy), and executes actions in that rule at step 722. As previously recited, asset connectors and/or device proxies in the EMS 110 are used to connect with said asset for executing actions in a rule. Further, execution of energy management policies involves performing action(s) on an asset, for example, changing the power state of an asset (on/off/hibernate). It will be understood that the EMS can perform various other changes to the power state of an asset, and not limited to those discussed herein. Even further, conditions can depend on several factors like date/time, location, network address, business unit, processor installed on asset, operating system running on asset, programs running on asset, runtime conditions on asset, etc, and are not limited to the embodiments disclosed herein. According to one embodiment of the present disclosure, a script developed by a programmer is used to specify conditions for executing energy management rules. According to another embodiment of the present disclosure, conditions are specified through a user interface by an EMS administrator.

After a current rule has been executed (at step 722) on a current asset, the EMS determines whether or not all rules in a policy table have been checked for application on the current asset. For example, in some circumstances, a given asset may be subject to more than one rule (i.e., the conditions in more than one rule may be satisfied by device information or power information associated with the given asset). Because of this possibility, in one embodiment, all rules are checked against a given asset, even if a rule is encountered that includes conditions that are satisfied by information associated with the asset. In this situation, and as will be understood and appreciated, although many rules may be executed against a given asset, only one rule will ultimately prevail and control (and its corresponding action will be executed). Specifically, in one embodiment, the steps shown in process 700 are executed virtually instantaneously and simultaneously, such that only the rule with the highest priority is truly implemented with respect to an asset. All other rules that might be satisfied by the asset are preempted before the action (e.g., changing the power state of a device) can be actually implemented, or the attempt at execution simply returns an error message to the EMS.

Once no rules remain to be checked against the current asset (no branch of decision step 712), the EMS moves to step 726 in which it determines whether all assets have been polled for execution of energy management policies. If all assets have been polled, process 700 reverts back to step 702 and the entire process 700 re-starts (e.g., after a pre-determined time delay, or immediately). An exemplary interface to configure a pre-determined time delay, and various other settings is shown in FIG. 15D.

Still referring to FIG. 7B, at step 726, if the policy engine 212 determines that all assets have not been polled, process 700 moves on to increment (at step 730) a second counter to point to the next asset in a list of devices (in the EMS database 112) that are managed. Then, step 706 is executed and rules are again checked against information associated with devices, starting from a first rule in a policy table. As will be understood, the steps of execution of rules (policies) of energy management as described in FIG. 7 are provided for exemplary purposes only. Execution of rules of energy management can be performed according to various alternate embodiments, as will be apparent to a person skilled in the art. For example, rather than iterating through devices for a given rule, a particular policy rule can be selected, and the devices that could pertain to that rule may be iterated. Once complete, a second rule could be selected, and so on.

Now referring to FIG. 8, an exemplary policy table 810 (stored in an EMS database 112) comprising a collection of policies or rules, is shown. As recited previously, these policies are generally created either during initialization of the EMS 110, or during normal operation, and stored in the EMS database 112. These policies/rules can be created/specified by an EMS administrator, or can be configured through a script developed using a scripting language, or preconfigured within the EMS, or developed in some other manner.

As described above, rules provide directions for performing actions with respect to an asset. A rule generally includes one or more conditions. Conditions represent criteria that are used to execute an action with respect to the device. Conditions for actions can be based on date/time, asset type, applications or programs running/not running on assets, custom scripts written by a programmer, business units, locations, run time conditions (for example, power consumed by assets, power state) of assets, etc. As can be seen from FIG. 8, an exemplary first rule indicates hibernating PC's housed in an Atlanta facility between the hours of 12 noon and 1 pm. In this exemplary rule, the action involved with changing the power state of devices is “hibernate”. Conditions include the type of assets (i.e., PC's), location (i.e., Atlanta) associated with such assets, and time duration (i.e., between 12 noon and 1 pm) for application of this exemplary rule. Actions and conditions associated with various rules are further illustrated in datatable 811.

As can be seen, a second exemplary rule in policy table 810 indicates turning off PC's in an Atlanta facility between the hours of 7 pm and 7 am. As will be understood, conditions associated with this rule are asset types (PC's), times of application of this rule (between 7 pm and 7 am), and the actions involved comprise of “turning off” and “turning on” assets (PC's).

Furthermore, a third exemplary rule in policy table 810 is illustrated that involves actions (turning off) with asset type (lights) at locations (Tokyo facility). Even further, a fourth exemplary rule in policy table 810 indicates actions (turning off) with asset type (HVAC) at locations (all facilities). As will be understood by a person skilled in the art from these exemplary rules, a variety of rules can be created, each rule further comprising of one or more conditions, in order to perform action(s) for the purposes of providing energy efficiency at homes and organizations. Further, rules, conditions and actions described herein are for the purposes of illustration only. Various other rules, conditions and actions involving different embodiments of the present disclosure can be created/specified. For example, actions need not necessarily relate to physically controlling a given asset—they might dictate that an email notification be sent to a system administrator, or that a certain item of information be stored in a database.

Turning now to FIG. 9, an exemplary device table 812 is shown comprising exemplary attributes associated with devices. The information shown in the device table 812 generally represents the types of information maintained in a device profile for each asset. As shown, the device table comprises attributes named “Date/Time Stamp”, “Device ID”, “Device Type”, “Status Type”, “Asset Connector”, “Host Name”, “URL”, “Model type”, and “System Type”. For example, the Date/Time Stamp column indicates a date and a time when a device was polled, or when a device profile was last updated. A Device ID column is a unique identifier for a device, a Device Type column identifies a type of device, a Status type column indicates a power state (for example, on/off/hibernate etc.) of a device at the date and time it was polled, an Asset Connector column specifies an associated asset connector for the device, a Host Name indicates a device label for various forms of IT network communication that a device utilizes, a URL (Uniform Resource Locator) identifies a network address for a device, a Model Type column indicates a model number for a device, and a System Type specifies a generic system or purpose associated with a device.

For example, as can be seen from the data entries in device table 812, on a Date/Time Stamp “2011-02-24 10:50 AM”, a device identified by a Device ID “412a702” is associated with a Device Type “PC.Windows”, i.e., a WINDOWS™ PC, in a Status Type (power state of device) “3”. As will be understood by a person skilled in the art, various power states may be represented in the EMS 110 as numbers, for example “0” may indicate a device is powered off, “1” indicates a device is on standby power mode, “2” indicates a device is in hibernate power mode, “3” indicates a device is powered on, etc. It will be understood that other numbering schemes can be used to represent various power states of a device, or that no numbering scheme be used.

Continuing with further attributes of a device identified by a Device ID “412a702” in device table 812, an Asset Connector “83907b8” is associated with this device, a Host Name “Test-PC2” labeling the device at a URL “10.64.54.27”. Further, Model Type for said device is specified as “DELL LATITUDE™ E6410”, said device having a System Type “Workstation”. It can be seen in FIG. 9 that values for Device ID and Asset Connector are expressed in hexadecimal number format, as is customarily used in representation of most electronic computing devices. However, as will be understood, other numbering systems can also be used, for example, decimal number format, etc. Additionally, it will be further understood that a URI (Uniform Resource Identifier) column can alternatively be used to identify a network address for a device, in place of URL (Uniform Resource Locator) column, as shown in device table 812. Furthermore, as will be understood by one having ordinary skill in the art, the device table 812 is presented for illustrative purposes only, and embodiments of the present system 110 are not limited to data, information, and fields in the specific data table shown.

Now turning to FIG. 10, an exemplary power data table 814 for storing data relating to power profiles of devices in connection with generating energy efficiency management reports, is shown. As shown, a power profile including various types of energy or power data is provided in table 814. As shown in FIG. 10, in one embodiment, power data table 814 includes columns named as “Date/Time Stamp”, “Device ID”, “Status Type”, “Power Consumed”, “Power Saved”, “Rule ID”, “Unit Type”, “Location” and “Power Price”. As recited previously, Date/Time Stamp column indicates a date and a time when a device was last polled, or when the power profile was last updated. Also, as previously recited, a Device ID column is an unique identifier for a device, and a Status type column indicates a power state (for example, on/off/hibernate etc.) of a device at the date and time it was polled. A Power Consumed columns indicates power consumed by a device, for a pre-specified duration of time. It will be understood by a person skilled in the art that power consumed by a device will vary depending on the duration of time a device has been operational, and thus for generating energy management reports, a duration is defined in the form of a date and time range. According to one embodiment of the present disclosure, an EMS administrator indicates such a duration through an interface. According to another embodiment of the present disclosure, a script developed by a programmer is used to specify such a duration.

Still referring to the power table 814 in FIG. 10, a Power Saved column indicates the power saved by executing energy management policies (for example, by hibernating, powering off, etc.) for a pre-specified duration of time. This column provides helpful measure of energy saved using various policies associated with the given device. Rule ID identifies a rule (more specifically, an energy management policy) that is executed on a device when it was polled. Thus, the Power Saved column generally relates to energy saved based on execution of the rule in the Rule ID column.

Continuing with FIG. 10, Unit Type column indicates a business unit or department associated with a device, Location column specifies a geographical location where a device is located, and Power Price column specifies a energy pricing rate (in price/kilowatt-hour, for example) for energy that is consumed by the device. As can be seen from the power table 814, on a Date/Time Stamp “2011-02-24, 10:50 AM”, a device identified by a Device ID “412a702” was in a Status Type (power state of device) “3”. As will be understood by a person skilled in the art, various power states are represented in EMS 110 as numbers, as described above.

Further, as seen from power table 814, a device identified by Device ID “412a702” is characterized with fields in Power Consumed column as “102.5”, indicating that said device has consumed 102.5 watts of power. Further, it can be seen that by executing an energy management policy identified as Rule ID “7e2f77e”, power saved by said device, as indicated in Power Saved column is “23.4” watts. Additionally, it can be seen that said device is located in a Unit Type “IT”, at a location “Berlin” and consuming energy with Power Price “0.2”, i.e. energy pricing rate for power consumed by device is $0.2/kilowatt-hour. As will be understood by one skilled in the art, energy pricing can be expressed in terms of other currencies as well. Again, it will be understood that the types of data and information shown in table 814 are presented merely for illustrative purposes only, and other types of data may be included. It will be further understood that by providing various energy and power measures for various types of device across an organization in one central system enables the organization to easily and efficiently manage power of all its devices organization-wide.

FIG. 11A and FIG. 11B illustrate different exemplary screen views 1100A and 1100B respectively, of a home page (dashboard summary of energy management) of an embodiment of the EMS 110 that are visible to an EMS administrator 116 for review and analysis purposes. As will be understood, these screen shots characterize energy-related information and associated analytics of assets that are housed in one or more facilities, often distributed at several geographical locations. As will occur to those skilled in the art, the EMS (e.g., via reporting engine 214) retrieves values of power consumed by various devices (pre-stored in the EMS database in device profiles and power profiles) along with additional device attributes from the EMS database and displays this information through an interface as displayed in screen shot 1100A and 1100B.

Referring first to FIG. 11A, region 1102 is a menu bar displaying various clickable menu selection choices, “Home”, “Policies”, “Devices”, “Reports”, “Apps”, “Settings”. The “Home” menu selection choice is shown highlighted because current screen shot displays the home page of an EMS 110 interface that reveals a dashboard summary of energy management. The “Policies” menu selection choice generally provides an interface to an EMS administrator 116 to interact and define various energy management policies. The “Devices” menu selection choice generally provides an interface to an EMS administrator 116 to review and manage power consumed by individual devices, and also to review non-power-related device-specific information. The “Reports” menu selection choice displays various reports related to power consumption, energy savings and various other analytics extracted from device profiles and/or power profiles of individual devices. As explained previously in detail in FIG. 5 and FIG. 6, in one embodiment, device profiles and power profiles are collected from individual devices by device monitoring engine 210 and policy engine 212 respectively, and pre-stored in an EMS database 112.

The “Apps” menu selection choice provides additional features and functionalities for the usage of mobile phone apps to monitor energy consumption and engage in energy savings and sustainability initiatives. Additionally, “Apps” menu selection choice also provides ways to improve the accuracy of measurement of consumed power of assets. As will be understood by a person skilled in the art, many legacy printers, PC's and other devices do not provide accurate measurement of consumed power, and hence for such devices, power consumed for devices is approximated by the EMS 110. Thus, for example, recommendations to improve the accuracy of measurement of consumed power of such assets, are also provided to an EMS administrator by clicking on the “Apps” menu selection choice.

The “Settings” menu selection choice generally provides an interface to an EMS user 116 to configure multiple options for the EMS 110, in connection with several functionalities. Examples of such functionalities include changing the username/password for an EMS administrator, importing asset information into the EMS 110, defining timezone settings and energy pricing for various assets, providing a list of “protected” assets that are excluded from being subjected to energy management policies, setting up network connections, and many other options that will occur to one skilled in the art.

Still referring to FIG. 11A, region 1104 displays an “energy bar” that reveals a brief summary of energy savings information (“Saved Energy” icon 1122), cost savings information (“Saved Cost” icon 1124), and savings in greenhouse footprint (“Saved C02” icon 1126) based on use of the EMS. For example, it can be seen from screen shot 1100A that 589.99 kWh of energy is saved that translates to $1200.36 savings in cost, and 0.24 kg of CO2 gases of savings in greenhouse footprint. Accordingly, region 1104 provides an overview of various energy and cost savings information that are a result of managing the devices in an organization via an embodiment of the EMS, such as be executing various energy-savings policies with respect to organization devices.

Furthermore, region 1104 also illustrates functionality for adding widgets to a homepage screen, using an “Add a Widget” button. System users reviewing a homepage screen click on this button which opens a dialog box (displaying several widgets) from which they can choose one or more widgets to customize the display of a homepage screen. In one embodiment, widgets provide specific information related to power savings, cost savings, power consumed, energy management rules, and even real time device and power-related information and various other attributes. Because the EMS performs the task of monitoring and managing different types of devices that are located at various facilities, locations, business units etc., different reports and analytics can be extracted connecting a variety of device-related and power-related attributes. By way of example, widgets may show information in relation to real time power utilization, detailed device information, statistics of energy consumption by device type, device location, and many more such informative statistics and reports, as will occur to those skilled in the art. An EMS administrator configures his or her screen shot, based on various statistics and reports that he or she may want to see. As will be understood by a person skilled in the art, an EMS interface is configured with a set of statistics and reports, by default. Exemplary screenshots shown in FIGS. 11A, 11B, 13 and 14 is configured using several widgets.

Still referring to FIG. 11A, region 1106 reveals an overview of current energy/power consumption as a consequence of executing energy management policies, and also a maximum energy/power that would have been consumed if energy management policies were not applied. For example, it can be seen that 0.32 kW of power is being currently consumed whereas 0.40 kW of power would have been consumed if energy management policies were not applied. In another embodiment, region 1106 provides information relating simply to an organization's current power utilization versus its maximum available power available.

Region 1108 in screen shot 1100A reveals graphical statistics in the form of a circular pie-diagram comprising various sectors representing various types of devices that are currently consuming power within an organization or facility. For example, one sector of the pie represents all WINDOWS™ devices, another sector represents switches, and so on. Generally, the area of each sector is proportional to the number (quantity) of devices within a facility of the same type, or to the total power being consumed by devices of that type. For example, it can be seen (in region 1108) that approximately half of the circular pie-diagram is occupied by WINDOWS™ devices, implying that WINDOWS™ devices are about a half of the total number of devices. Quantities of other devices, for example, switches, generic devices (that do not have an associated asset management system), Linux operating system-based devices, etc. are also shown in the circular pie-diagram. As will be understood and appreciated, total power consumed by devices of different types, can also be shown with the help of a pie-diagram or other graphical display.

Referring now to region 1110 in FIG. 11A, a graph reveals a current total power demanded by all devices, as a function of time of the day. For example, in region 1110 it can be seen that total power demanded prior to 8 am is virtually zero (0) kilowatt, but this value increases to about 0.3 kilowatt by 8:30 am, and remains at that value till 9:30 am, after which it increases slightly. Thus, it becomes clear that the power for this exemplary organization increases significantly as employees arrive at the office and power on their respective devices (or as the EMS begins powering on various devices automatically based on predetermined power policies/rules). Further, region 1112 in FIG. 11A indicates total power consumption and associated cost, broken down by various types of devices. For example, it can be seen that switches consume 18.42 kWh of energy, and associated cost is $3.23 (per some predefined time period, e.g., per hour). Also, it can be seen from region 1112 that WINDOWS™ PC's consume 8.98 kWh of energy, and associated cost is $1.31. Power consumed by various types of devices are also represented with shaded horizontal bars, wherein the ratio of the length of the shaded region to the length of the bar graph corresponds to the power consumed by a type of device. As will be understood and appreciated, various power and device information display regions (widgets) may be utilized according to various embodiments of the EMS.

Now referring to FIG. 11B, a screen shot 1100B revealing another dashboard summary of energy management of an embodiment of the EMS 110 is shown. In screen shot 1100B, region 1114 (comprising icons 1128, 1130, 1132, and 1134) displays summary information of devices that are monitored and managed by the EMS. As shown, the total number (quantity) of devices is displayed in region 1128, number of devices that are powered on is displayed in region 1130, number of devices that are powered off is displayed in region 1132, and number of devices that are subject to policies is displayed in region 1134. As will be understood, the regions and quantities shown in regions 1128, 1130, 1132, and 1134 are for illustrative purposes only, and embodiments of the EMS 110 are not limited to the specific information shown.

Continuing with exemplary screen shot 1100B, region 1116 displays current status information of an embodiment of the EMS, for example, whether the EMS is executing energy management policies or not. As shown in exemplary region 1116, a “Running” icon 1136 indicates that policies are currently being executed on various assets. An EMS administrator can click the “Stop” button 1138 to stop executing energy management policies on various assets. In addition, region 1116 also displays a current date and time reported by the EMS.

Still referring to FIG. 11B, region 1118 displays information pertaining to real time energy consumption of assets. This information can be displayed based on different geographical locations, different types of devices, and several other factors. Furthermore, such information can be reported every minute, every hour, every two hours, or at virtually any other defined time interval. Menu button 1140 provides functionality to choose various time intervals at which information pertaining to real time energy consumption of assets is reported. Menu button 1142 is used to choose various power-related statistics and metrics, for example, minimum and maximum average power consumed, real time power consumed by all devices, average power consumed by devices that are turned on, and various other metrics. These metrics are further illustrated graphically. For example, as shown in region 1118, real time power consumed by all devices housed at various locations are illustrated with a circular pie-diagram in which sectors of the pie-diagram represent various locations that are managed by the EMS. As will be understood, assets (devices) are housed in facilities at different geographical locations, for example, Paris, Berlin, Tokyo, London, etc. Energy consumed by individual assets are measured, monitored and controlled by the EMS. As can be understood by a person skilled in the art, energy consumed by individual assets located at a geographical location is used to obtain a total energy consumed by assets located at that geographical location. Thus, total energy consumed by assets is displayed as a pie-diagram (comprising of several sectors) where area of a sector of the pie-diagram is proportional to the total energy consumed by assets at a geographical location. As will be understood and appreciated, other reporting and analytical tools, such as bar graphs, line diagrams, number displays, and the like may be used as opposed to a pie chart.

Referring to FIG. 12, comprising FIGS. 12A, 12B, and 12C, illustrative screenshots 1200A, 1200B, and 1200C are shown of exemplary EMS interfaces for creating and managing policies (or rules) for management of energy efficiency for various devices. As shown in FIG. 12A, in one embodiment, a rule is specified by clicking button 1203 (“Add New Rule”). Although not shown here, it will be understood that clicking button 1203 opens up a dialog box for specifying a name of a rule, and also conditions (by clicking on a “Conditions” button) and actions (by clicking on an “Actions” button) associated with a rule. For example, it will be understood that clicking on “Conditions” button 1205 opens up a dialog box, and an EMS administrator can specify, define, or select one or more conditions. As recited previously, conditions are based on a combination of one or more of the following attributes: asset type, asset location, date and/or time, or even a time-pattern (daily, weekly, hourly, etc.), software programs running on assets, and various others. According to one embodiment of the present disclosure, scripts can be used to specify conditions, rules, actions, perform queries, and various computational tasks, written by a software developer, and provided to the EMS through an interface. In another embodiment, various available conditions and actions are selected from a predetermined list or drop down menu of available conditions and actions. In addition, as will be understood by one skilled in the art, conditions can be triggered by specific red-flag events like emergencies, fires in a facility, power outages, any various other events. Generally, the EMS obtains information regarding the occurrence of such event(s) from asset management systems located at facilities, or from other sources. A pre-stored script written by a programmer may instruct the EMS to override regular EMS operating rules.

In screen shot 1200A, region 1202 displays a “Rules Menu” that is used to control the creation, management, and display of various rules. For example, a system user reviewing this interface can choose to review rules that are enabled, or, rules that are disabled, or all rules consisting of both enabled as well as disabled rules. As recited previously, enabling a rule causes a rule to be activated, whereas disabling a rule causes it to be deactivated. In other words, if a rule is disabled, it is not executed by the EMS, although it is specified in a policy table in EMS Database 112. According to one embodiment of the present disclosure, an EMS administrator enables (or disables) rules using a slider button 1207. As can be understood by a person skilled in the art, a slider button is a graphical user interface control that moves horizontally to the right/left inside a region and is used to turn on/turn off features in an interface. Thus, a policy is enabled or disabled by moving Slider button 1207 to an ON or OFF position. For example, an exemplary rule displayed in region 1212 is turned off (disabled), whereas another rule displayed in region 1208 is turned on (enabled). As can be seen from region 1202, “All Rules” is shown highlighted indicating that a human EMS administrator chooses to review both enabled and disabled rules. As will be further understood, a “slider button” is but one exemplary way for a system user to manipulate rules to control whether they are activated or deactivated, and any other conventional mechanism for doing so is within the scope of the present disclosure.

Still referring to screen shot 1200A, button 1204 (“Conditions and Actions”) and button 1206 (Statistics) provide control of display (to an EMS administrator) of various rules. In particular, clicking on button 1204 causes the conditions and actions associated with a rule to be displayed. Further, clicking on button 1206 causes various statistics (related to number of devices being controlled by the EMS and savings obtained, as explained later) to be displayed.

As can be seen from screen shot 1200A, region 1212 displays a rule that is entitled “ALL Hibernate For Lunch”. Associated conditions (displayed in region 1205) for this rule indicate conditions including assets on which this rule is executed (WINDOWS™ PCs and LINUX™ PCs which have a screensaver program running on weekdays). Although not shown in screen shot 1200A, it will be understood that times of the day during which this rule is executed is also specified, for example, between 12 noon and 1 pm. Additionally, it will be understood that this rule is executed on assets housed at every location (given that a location is not specified). Associated actions (displayed in region 1205) for this rule indicate hibernation of assets (“Hibernate” icon 1213). Further, it can also be seen that additional statistics related to the number of devices being controlled, cost savings and energy savings are also displayed. For the exemplary rule displayed in region 1208, it can be seen that the total number of devices being controlled by this rule is “980”, and as a consequence of hibernating these devices between 12 noon and 1 pm, total saved cost is $2500.63 and total saved energy is 35.9 kWh.

As can be seen from exemplary screen shot 1200A, region 1208 displays another rule entitled “Sales Atlanta Off”. It can be further seen in region 1208 that conditions (displayed in region 1205) for this rule indicate “All devices in Sales Unit in Atlanta”, and actions (displayed in region 1209) for this rule indicate “Power Off”. As will be understood, this rule involves switching off all devices in the sales business unit located in the Atlanta location. Furthermore, additional statistics relating to the number of devices being controlled, cost savings and energy savings are also displayed. For the exemplary rule displayed in region 1208, it can be seen that the number of devices being controlled in the sales business unit in Atlanta is “75”, and as a consequence of powering off these devices, total saved cost is “$450.32” and total saved energy is 5.2 kWh.

A third exemplary rule is displayed in region 1210 that indicates “WINDOWS™ managed OFF” implying devices that are controlled by WINDOWS™ software are turned off. As can be seen from region 1210, conditions associated with this rule apply to all WINDOWS™ PCs that have a screen saver program as well as additional programs that are shown in FIG. 12B. In other words, by clicking on “Screen-Saver Is On, Check Apps” icon opens up a dialog box as displayed in FIG. 12B (described below). Further, actions associated with this rule follow a time-based pattern, the details of which are explained in connection with FIG. 12C. For the exemplary rule displayed in region 1210, the number of devices that are managed by this rule are indicated as “255”, total savings in cost is “$695.30”, and total saved energy is 10.5 kWh.

As will be understood and appreciated, embodiments of the EMS may utilize virtually unlimited numbers of rules to control assets managed by the EMS, and those shown in connection with FIG. 12A are provided merely for illustrative purposes.

Now referring to FIG. 12B, a screen shot 1200B of an interface is shown, illustrating conditions for creating energy management policies. In the exemplary interface 1200B, a policy based on various software programs on PCs is illustrated. As shown, region 1217 (comprising regions 1218, 1220 and 1222) in screen shot 1200B displays several software programs that comprise conditions associated with a rule. In one embodiment, these software programs are defined by an EMS administrator through the interface shown. For example, as can be seen from region 1218 in screen shot 1200B, a condition indicates that the EMS determines the status of a screen saver program only when screen saver program is running This condition is chosen by an EMS administrator by clicking on a toggle check box. Alternatively, un-clicking on the toggle check box in region 1218 results in the EMS determining the status of a screen saver program when screen saver program is not running.

Region 1220 in screen shot 1200B indicates software programs that are to be running on PCs to initiate an action associated with a rule. Exemplary software programs include “IDLE.EXE”, and several other such programs that can be specified by an EMS administrator through the interface. As can be understood by a person skilled in the art, “IDLE.EXE” is a program that is run by a WINDOWS™ Operating System when a PC is idle. Hence, it will be understood that for the exemplary rule displayed in region 1210 of screen shot 1200A, one of the conditions required for an action (powering off) to be executed is that software programs as indicated in region 1220 are to be running on PCs. Further, region 1222 in screen shot 1200B indicates software programs that are not running on PCs for executing an action. For example, it can be seen that “Word.exe”, “Powerpoint.exe”, and “Excel.exe” are not to be running on PCs for an action (powering off) to be executed. As will be understood, the information, conditions, software programs, and other parameters indicated in FIG. 12B are for illustrative purposes only. Embodiments of the present disclosure can include various other types of information and different display interfaces, as will occur to those skilled in the art.

Still referring to FIG. 12B, a “Submit” button 1224 submits conditions (for defining various rules), for example, as indicated in screen shot 1200B, to the EMS. As will be understood, these conditions are saved in the EMS database 112 to be executed with respect to assets. A “Cancel” button 1226 cancels conditions as specified in screen shot 1200B, and as a result, the rule would not be created or saved.

Now referring to FIG. 12C, an exemplary interface is shown for specifying time-based conditions associated with energy management policies. As will be understood, this exemplary interface is used to specify an action involving a change in power state (for example, turning on, turning off, hibernate mode, standby mode), days of the week (for example, Monday, Tuesday, etc.), and time(s) of the day when a change in power state is executed over a twenty-four time period for various devices covered by this rule. A menu selection button 1228 indicates that conditions follow a time-based pattern (for example, as displayed in region 1234) for executing actions corresponding to energy management policies. As can be seen from region 1234, assets are turned on at 7 am on weekdays, put in hibernate mode between 12 noon and 1 pm, turned back on at 1 pm, and turned off at 7 pm. Region 1232 indicates a legend that explains the meaning of various icons used in the time-based pattern shown in region 1234. So, for example, there is one icon for turning on, another icon for turning off, a third icon for hibernate mode, and a fourth icon for standby mode. As will be understood, devices can be in different time zones, and even an EMS administrator can be in a different time zone. Hence, a toggle check box 1240 is used to select an option that indicates that a time-based pattern in region 1234 follows same time zone as devices being managed by the EMS. A “Submit” button 1236 is used to submit a time-based, for example as indicated in region 1234, to the EMS. A “Cancel” button 1238 is used to cancel selection of time-based condition, for example as specified in screen shot 1200C.

Referring now to FIG. 13, an exemplary EMS interface for management of power consumed by individual devices is shown in screen shot 1300. As described previously, an embodiment of the device monitoring engine 210 monitors power consumed by various devices and saves it in the EMS database. Reporting engine 214 then retrieves values of power consumed by various devices along with additional device attributes from the EMS database and displays this information through an interface as displayed in screen shot 1300. As can be seen, a “Select Devices” navigation pane is used to select device related information, based on various attributes. Accordingly, power consumed by various devices is displayed (in region 1332), along with various associated attributes for such devices in region 1306. Referring to “Select Devices” navigation pane, all devices are selected by clicking on “All Device” button 1304, or devices are selected based on system types by clicking on “System Types” button 1318. Exemplary system types (work station, network printer, etc.) and other device attributes are illustrated in FIG. 9.

In screen shot 1300, devices are selected by manufacturer by clicking on “Manufacturer” button 1320, or by location by clicking on “Location” button 1322. Further, in screen shot 1300, devices are selected by business unit by clicking on “Business Unit” button 1324, or by type of device by clicking on “Device Type” button 1326. As will be understood, clicking on buttons (for example “Location” button 1322, or “Business Unit” button 1326) in the navigation pane causes the information to be displayed as a list in region 1306. Devices are selected by power state (e.g., on/off/hibernate etc.) by clicking on button “Status” button 1328. As can be understood by a person skilled in the art, devices can also be selected based on the energy management rules with which they are associated. Exemplary energy management rules are described in FIG. 10, and FIGS. 12A-12C. “Rule” button 1320 in screen shot 1300 is used to select devices that are associated with or covered by a given rule.

Further, as can be seen, a search box 1301 along with a “Search” button 1302 provides functionalities to search for devices based on several attributes like device ID, host name, and various other attributes, in order to add such devices to a list. According to one embodiment of the present disclosure, a query language can be used to query devices. Examples of query languages include Sql, MySql, and many others. In region 1306, clicking on “Add Device” button 1308 adds a device to a list of devices displayed in region 1306. Clicking on “View/Edit” button 1310 allows an EMS administrator to view or edit additional device related information. Further, a delete button 1312 removes a device from management by the EMS. In a situation in which a large number of devices are managed by an EMS, a forward and backward scroll button 1342 is provided in screen shot 1300 to scroll through multiple reports displayed in multiple screens of an interface. Further, it can be seen that a scroll bar 1344 is provided to allow an EMS administrator who is reviewing reports to vertically scroll up and down a screen.

FIG. 14 illustrates an exemplary EMS interface 1400 showing summary reports of power consumption, energy savings, and various system statistics in real and non-real time. As shown, a left navigation pane (region 1404) allows an EMS administrator to review such summary reports daily (by clicking on “Today” button 1406), weekly (by clicking on “Week” button 1408), or monthly (by clicking on “Month” button 1406) for analysis. As can be seen, button 1406 is highlighted indicating that a current screen is displaying daily summary reports. Exemplary daily summary reports are shown in regions 1420, 1422, 1424, and 1426. Region 1420 displays a daily summary report showing average saved energy cost as a function of time of the day. For example, it can be seen that average saved energy cost (e.g., per device) is zero until about 18:00 hrs (military time) and then increases to $0.04, afterwards. Total energy consumption by all devices (as a function of time) is reported in real time as displayed in region 1422. For example, it can be seen that total energy consumption is 250 kWh between 9 am and 11 am. Savings in energy cost and total energy consumption for assets located in various geographical locations are illustrated in regions 1424 and 1426 with horizontal bar plots. As will be understood by a person skilled in the art, statistics related to costs and power consumption can be displayed in various other ways.

Furthermore, it can be seen from region 1404 that an EMS administrator can obtain detailed reports by clicking on “Detailed Reports” button 1412. Various combinations of energy consumption, costs, savings, device types, carbon emissions, device models, and other such attributes can be used to obtain detailed reports. According to one embodiment of the present disclosure, the EMS analyzes device and power-related data and provides recommendations for obtaining additional savings. Results of such analysis and recommendations are obtained by clicking on “Energy Savings” button 1414. An EMS administrator can choose a pre-determined set of custom reports (both summary as well as detailed reports) that he or she wishes to review. Generally, such reports are automatically saved by the EMS in an EMS Database. A list of such reports are displayed when “Favorite Reports” button 1416 is clicked. Although not shown here, it will be understood that EMS also allows custom reports to be exported to a folder in an EMS administrator's computer. Region 1418 displays a current energy pricing rate used in calculating costs and savings, in connection with displaying various reports. As can be see, a default energy pricing rate assumed by EMS is $0.1 which can be edited by an EMS administrator by clicking on an “Edit” button 1500C. Further details of the interface for editing or setting energy pricing rates are illustrated in FIG. 15C.

Now referring to FIG. 15A, an exemplary interface 1500A for importing device information from a facility (and an asset management system) into an embodiment of the EMS is shown. As described previously, according to one embodiment, information regarding various devices is retrieved via an implementation engine within the EMS management module, as described earlier in FIGS. 4 and 5. In FIG. 15A, a left navigation “Settings” pane 1502 provides configuration settings for various features of the EMS. Examples of such configuration settings include functionalities to import devices (i.e., retrieve device information and store it in an EMS database) into the EMS, exporting device data from EMS to an EMS administrator's local computer, and providing custom data fields in the EMS. Generally, custom data fields are additional data fields that an EMS administrator chooses to extract from various devices during monitoring of such devices. Additionally, settings to provide a list of protected devices that are not subjected to energy management rules may be provided by an EMS administrator by clicking on “Protected Devices” button 1500B (described in greater detail in FIG. 15B). Configuration settings pane 1502 also include options to specify device locations explicitly, or in cases when device locations are not obtained from asset management systems. Further configuration settings include options to provide energy pricing rates (by clicking on button 1500C) for various markets, utilities or geographical locations. An exemplary screen shot showing energy pricing rates is shown in FIG. 15C.

Configuration settings pane 1502 also provides functionalities for indicating time zones in which devices are located. Options for setting software updates are also provided in configuration settings pane 1502. In one embodiment, the EMS also provides a crowd-sourcing capability to anonymously share device and power-related information for facilities amongst various organizations and entities. Internet connections and proxy server settings to enable crowd-sourcing functionality are also provided in configuration settings pane 1502. As recited previously, embodiments of the EMS are typically installed at a computer server in a facility. According to one embodiment of the present disclosure, an EMS administrator remotely manages the EMS through a web interface. Internet settings are provided (“Systems/Networking” button 1500D, described in FIG. 15D) in configuration settings pane 1502 to set up remote management of the EMS. Additionally, one or more EMS administrators may be involved in managing the EMS. Settings for providing email addresses of such administrators and time intervals when email notifications are sent by an EMS is configured through configuration settings pane 1502.

As can be seen in screen shot 1500A, settings for importing devices are shown highlighted in the current screen shot. As recited previously, asset connectors generally comprise a suite of software tools that are used to discover and import asset information into the EMS, with the help of asset management systems. Examples of functions of asset connectors include import of all WINDOWS™ computers from an asset management system such as Active Directory, etc. Asset connectors are added by clicking on “Add Asset Connector” button 1506 in the EMS interface 1500A.

As will be understood by a person of ordinary skill in the art, multiple asset connectors are pre-stored in an EMS for discovering, communicating with, and importing information relating to various types of assets. Further, information pertaining to an asset can involve multiple asset connectors. A “Refresh All Devices” button 1508 synchronizes and updates information from various devices in the EMS. As recited previously (with reference to discussion on energy management rules, in FIG. 7), asset connectors can be enabled or disabled. Region 1510 in screen shot 1500A displays an exemplary list of asset connectors. Region 1512 indicates whether an asset connector in this list is enabled (on) or disabled (off). Region 1514 displays names of asset connectors (for example, VoIP phones, WINDOWS™ PC, or even Networking Management for managing assets like switches and routers), region 1516 displays types of assets for which an asset connector is associated.

Still referring to FIG. 15A, a “Status” field 1518 indicates the number of assets controlled by an asset connector. Further, settings button 1521 is used to provide additional settings with a respective asset connector. Generally, different asset connector settings are configured differently, as they communicate with different asset management systems. For example, a WINDOWS™ PC based asset connector integrates with a WINDOWS™ based asset management system like Active Directory. Configuring a WINDOWS™ based asset connector generally requires a domain name, a host name of a network where Active Directory is located, along with username and password of individuals who are allowed to access Active Directory. In another example, an asset connector for VoIP phones integrates with a CISCOWORKS™ asset management system at one or more facilities. Configuring such asset connectors generally requires a CISCOWORKS™ URL, along with a username and password of individuals who are allowed to access CISCOWORKS™ asset management system.

After devices are imported using asset connectors (i.e., after device information is retrieved), an EMS administrator clicks on “Save Changes” button 1520 in order to store associations (in an EMS database) between asset connectors and individual assets, as shown for example in region 1510. Alternatively, an EMS administrator can cancel changes done (in this screen) in relation to importing assets, by clicking on “Revert All Changes” button 1522. Detailed flowcharts showing steps of importing assets by an implementation engine are described in FIGS. 4 and 5.

In many scenarios, an important asset needs to be powered on at all times. Such a situation arises, for example, in facilities like hospitals where surgeries are performed, or in scientific or defense laboratories where critical experiments are being conducted, or even for some servers, HVAC equipment, or other devices in a facility that should always remain operational. For these types of devices, it is crucial to monitor and maintain an uninterrupted power supply for these critical devices, and ensure they are not accidentally powered off or hibernated. Thus, these devices generally should be excluded from otherwise applicable energy policies, and not be exposed to a change in power state. FIG. 15B shown an exemplary screenshot 1500B of an interface that is used to specify such assets. As can be seen, region 1524 shows various ways of specifying devices that are “protected” from energy management rules. Ways of specifying such devices include IP address associated with a device, or, by type of device (for example, LINUX™ PCs), or devices can be specified based on their location. Further, if multiple devices are to be protected, then a range of IP addresses associated with such devices are specified.

FIG. 15C shows an exemplary screen shot 1500C of EMS configurations for setting an energy pricing rate for purposes of generating various metrics and statistics used in energy management reports. As will be understood, an EMS administrator provides inputs for various quantities as displayed in screen shot 1500B. A “Currency” box 1528 is used to enter a currency (for example, dollar, euro, etc.) for a pricing rate. “Add location” button 1530 is clicked to add a geographical location (for example, London, Melbourne, Tokyo etc.). A pricing rate (measured in price per kWh) used at a location, along with equivalent greenhouse gas emission (measured in kg per kWh) as a result of energy consumed, are also entered. After a location, a pricing rate and greenhouse footprint is added, they are displayed in regions 1536 (“Locations”), 1538 (“Price Per kWh”), and 1540 (“CO2 Emission [Kg/kWh]”). Locations are edited by clicking on “Edit” button 1532, and deleted by clicking on “Delete” button 1534. After EMS administrator provides a location, energy pricing rate and greenhouse emission value, “Save Changes” button 1542 is clicked, and thereafter they are saved in an EMS database. However, an EMS administrator cancels saving them by clicking on “Revert All Changes” button 1544.

As will be understood, pricing information for energy rates may be provided in a default setting without any customization by an EMS user. However, the functionality illustrated in screen 1500C enables an EMS user to customize its energy pricing information and displays according to the user's preferences. For example, a standard energy cost may be provided to the EMS by a local utility company as the default cost. However, an EMS user that has negotiated a cheaper energy rate with the utility company can customize the energy cost settings according to this new rate to provide accurate energy savings analytics.

Referring now to FIG. 15D, an exemplary screen shot 1500D is shown with various system settings relating to storage of information, notifications and errors, networking settings, and the like. As can be seen, clicking on button 1548 displays a drop down menu which contains various options for creating log files. Examples of such options include a “DEBUG” option in case of errors and simplifies troubleshooting, a “WARNING” option displaying log warnings, errors and fatal errors, as well as a “NONE” options for not logging any entries. As will be understood, log files that are created from recording various events and errors, are stored in the EMS database.

Region 1550 in screen shot 1500D shows various buttons to configure different settings of the EMS. As will be understood, generally speaking, embodiments of the EMS perform network based management of electrical and electronic devices (assets) for purposes of providing energy efficiency. In order to perform such management, EMS (specifically, asset connectors and/or device proxies) continually poll devices at periodic intervals of time to determine their power state (on/off/hibernate etc.). Button 1552 is provided to determine the periodic interval of time at which power state of devices are polled. In exemplary screen shot, it can be seen that this interval is set at “5 minutes”. Further, button 1554 provides settings to adjust periodic time intervals at which power consumed by a device is measured. This is shown as “30 minutes” in screen shot 1500D. As previously recited, asset connectors communicate with existing asset management systems at the facilities to import new assets into EMS, and also determine whether existing assets are connected or not. As a result, button 1556 is provided to set time intervals at which assets are refreshed. In exemplary screen shot 1500D, time intervals at which assets are refreshed is set at “30 minutes”.

Region 1558 provides various toggle check boxes in order to select specific network settings. As described previously, assets (devices) are typically connected to an IT infrastructure at a facility. Thus, the EMS accesses various devices using their hostnames and IP addresses. In many scenarios, devices like laptops switch from a Local Area Network (LAN) to a Wireless Local Area Network (WLAN), for example when individuals move their laptops from their office desks to conference rooms. As will be understood by those skilled in the art, IP address of devices that are moved changes. Consequently, a “DNS Resolve” option is provided in one embodiment of the EMS that resolves a hostname of a device to a current IP address every time a device is accessed.

As will be understood by a person skilled in the art, the Ethernet is a computer networking standard for communication between two computers. According to this standard, communication between two computers involves the exchange of information packets that essentially are a sequence of data bits in the form of zeros and ones. In one particular embodiment, when managing PCs located in a facility, the EMS uses a special kind of Ethernet network packet for turning on PCs over a computer network (i.e., for controlling the PCs remotely via the EMS). This special network packet is broadcast to a PC's Medium Access Control (MAC) address. A network interface card connected to a PC continually (even when a PC is turned off) probes for incoming packets. In region 1558 in FIG. 15D, a toggle check box option is provided that allows an EMS administrator to choose whether or not to change the power state of a PC by sending such a special network packet. Configuration settings provided by an EMS administrator are saved in an EMS database by clicking on “Save” button 1559 provided in the interface. As will be understood, system configuration settings presented in FIG. 15 are intended for illustrative purposes only, and other system configurations are possible according to various embodiments of the present systems.

As recited repeatedly throughout this disclosure, embodiments of the EMS are able to communicate with varying types of electronic devices remotely via predetermined communications algorithms (e.g., device proxies). This communication often entails sending instructions to the respective devices to initiate some action with respect to the power states of the devices. It will be understood and appreciated that, in one embodiment, this control is accomplished by providing instructions to IP-enabled devices that are pre-programmed to enable remote control and functioning based on the provided instructions. As will be understood, remote control of devices can occur via any specific mechanism as will occur to one of ordinary skill in the art.

As described in detail above, aspects of the present disclosure generally relate to systems and methods for managing and monitoring a plurality of assets (in real time as well as in non-real time) using an energy management system (EMS). Additional aspects relate to easily and efficiently installing (for example, with a simple plug-and-play mechanism) an EMS to manage, monitor, and control pre-existing assets at one or more facilities. Also, aspects of the present disclosure relate to normalizing asset information across varying vendors, makes, and models of assets that are located at various geographically distributed facilities, for management of heterogeneous, distributed assets via a single interactive dashboard interface. Further, aspects of the present disclosure are directed to generating various reports containing operational information relating to the assets, actual (and projected) cost savings and greenhouse emissions based on actions taken with respect to the assets, and analytics related to energy management that are utilized by organizations (entities) and private individuals to develop strategies for optimum energy efficiency management.

Accordingly, it will be understood that various embodiments of the present system described herein are generally implemented as a special purpose or general-purpose computer including various computer hardware as discussed in greater detail below. Embodiments within the scope of the present invention also include computer-readable media for carrying or having computer-executable instructions or data structures stored thereon. Such computer-readable media can be any available media which can be accessed by a general purpose or special purpose computer, or downloadable through communication networks. By way of example, and not limitation, such computer-readable media can comprise physical storage media such as RAM, ROM, flash memory, EEPROM, CD-ROM, DVD, or other optical disk storage, magnetic disk storage or other magnetic storage devices, any type of removable non-volatile memories such as secure digital (SD), flash memory, memory stick etc., or any other medium which can be used to carry or store computer program code in the form of computer-executable instructions or data structures and which can be accessed by a general purpose or special purpose computer, or a mobile device.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the invention may be implemented. Although not required, the inventions are described in the general context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, objects, components, data structures, etc. that perform particular tasks or implement particular abstract data types, within the computer. Computer-executable instructions, associated data structures, and program modules represent examples of the program code for executing steps of the methods disclosed herein. The particular sequence of such executable instructions or associated data structures represent examples of corresponding acts for implementing the functions described in such steps.

Those skilled in the art will also appreciate that the invention may be practiced in network computing environments with many types of computer system configurations, including personal computers, hand-held devices, multi-processor systems, microprocessor-based or programmable consumer electronics, networked PCs, minicomputers, mainframe computers, and the like. The invention is practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the inventions, which is not illustrated, includes a general purpose computing device in the form of a conventional computer, including a processing unit, a system memory, and a system bus that couples various system components including the system memory to the processing unit. The computer will typically include one or more magnetic hard disk drives (also called “data stores” or “data storage” or other names) for reading from and writing to. The drives and their associated computer-readable media provide nonvolatile storage of computer-executable instructions, data structures, program modules, and other data for the computer. Although the exemplary environment described herein employs a magnetic hard disk, a removable magnetic disk, removable optical disks, other types of computer readable media for storing data can be used, including magnetic cassettes, flash memory cards, digital video disks (DVDs), Bernoulli cartridges, RAMs, ROMs, and the like.

Computer program code that implements most of the functionality described herein typically comprises one or more program modules may be stored on the hard disk or other storage medium. This program code, as is known to those skilled in the art, usually includes an operating system, one or more application programs, other program modules, and program data. A user may enter commands and information into the computer through keyboard, pointing device, a script containing computer program code written in a scripting language or other input devices (not shown), such as a microphone, etc. These and other input devices are often connected to the processing unit through known electrical, optical, or wireless connections.

The main computer that effects many aspects of the inventions will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), and wireless LANs (WLAN) that are presented here by way of example and not limitation. Such networking environments are commonplace in office-wide or enterprise-wide computer networks, intranets and the Internet.

When used in a LAN or WLAN networking environment, the main computer system implementing aspects of the invention is connected to the local network through a network interface or adapter. When used in a WAN or WLAN networking environment, the computer may include a modem, a wireless link, or other means for establishing communications over the wide area network, such as the Internet. In a networked environment, program modules depicted relative to the computer, or portions thereof, may be stored in a remote memory storage device. It will be appreciated that the network connections described or shown are exemplary and other means of establishing communications over wide area networks or the Internet may be used.

In view of the foregoing detailed description of preferred embodiments of the present invention, it readily will be understood by those persons skilled in the art that the present invention is susceptible to broad utility and application. While various aspects have been described in the context of a preferred embodiment, additional aspects, features, and methodologies of the present invention will be readily discernable from the description herein, by those of ordinary skill in the art. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present inventions. In addition, some steps may be carried out simultaneously.

Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

What is claimed is:

1. In an energy management system, a method for remotely monitoring and controlling a plurality of electronic devices associated with one or more facilities, the method comprising the steps of:
retrieving device information corresponding to characteristics of a particular device housed at a facility, wherein the device information comprises preexisting information maintained within an asset management system;
based on the retrieved device information for the particular device, selecting a predetermined device communications module that enables remote communications with the particular device;
via the predetermined device communications module, identifying current energy information for the particular device;
retrieving a predefined energy rule for the particular device, wherein the predefined energy rule dictates an action to be taken with respect to the particular device based on satisfaction of one or more conditions associated with the energy rule;
determining whether the predefined energy rule has been satisfied for the particular device as a function of the retrieved device information or the current energy information for the particular device; and
if the predefined energy rule has been satisfied for the particular device based on satisfaction of the one or more conditions associated with the energy rule, remotely executing the action mandated by the energy rule via the predetermined device communications module for the particular device.

2. The method of claim 1, wherein the device information is selected from the group comprising: device type, device model, device name, primary device user, physical device location, virtual device location, device capabilities, device operating system, network to which the particular device is connected, business unit of the particular device, whether the particular device is IP-enabled, whether the particular device includes preexisting power sensors.

3. The method of claim 1, further comprising the step of generating a unique device profile based on the retrieved device information for the particular device, and storing the unique device profile in a database.

4. The method of claim 3, wherein the unique device profile includes device information merged from a plurality of asset management systems associated with the one or more facilities.

5. The method of claim 4, wherein the step of determining whether the predefined energy rule has been satisfied for the particular device is based on the unique device profile.

6. The method of claim 1, wherein the step of retrieving device information corresponding to characteristics of a particular device occurs via use of a predetermined asset connector module that enables communication with the asset management system.

7. The method of claim 1, wherein the predetermined device communications module is selected from a group of predetermined device communications modules that are standardized to enable a unitary communication mechanism to a user of the energy management system.

8. The method of claim 1, wherein the predetermined device communications module is a device proxy corresponding to the device type of the particular device.

9. The method of claim 1, wherein the predetermined device communications module is maintained and operated at a central energy management system server, and is not installed directly on the particular device.

10. The method of claim 1, wherein the step of selecting the predetermined device communications module further comprises the steps of:
extracting device type information from the retrieved device information that indicates a device type for the particular device;
analyzing the device type information to determine a particular device type for the particular device; and
identifying the predetermined device communications module corresponding to the particular device type from amongst a plurality of predetermined device communications modules corresponding to a plurality of device types.

11. The method of claim 10, wherein the device types comprise devices capable of being controlled within an information technology (IT) network.

12. The method of claim 1, further comprising the step of generating a unique power profile based on the current energy information for the particular device, and storing the unique power profile in a database.

13. The method of claim 12, wherein the step of determining whether the predefined energy rule has been satisfied for the particular device is based on the unique power profile.

14. The method of claim 1, wherein the current energy information indicates a current energy state of the particular device, and wherein the current energy state is selected from the group comprising: on, off, hibernate mode, standby mode, startup mode, shutdown mode, reduced power mode, idle mode, charging mode.

15. The method of claim 1, wherein the current energy information comprises a current utilization of the particular device.

16. The method of claim 1, wherein the current energy information comprises energy consumption information for the particular device.

17. The method of claim 16, wherein the energy consumption information for the particular device is identified directly via energy output sensors that are preinstalled on the particular device.

18. The method of claim 16, wherein the energy consumption information for the particular device is identified according to the following steps:
identifying components operating within the particular device;
retrieving a current energy state for the particular device;
retrieving a lookup table of standard energy consumption values for specific device components for the current energy state of the particular device; and
calculating an estimated total energy consumption for the particular device based on the current energy state of components within the particular device.

19. The method of claim 16, wherein the energy consumption information for the particular device is identified based on historical information for average energy consumption values for similar devices operating under similar energy states.

20. The method of claim 1, wherein the predefined energy rule is defined by a user of the energy management system to enable remote control of the particular device.

21. The method of claim 1, wherein the step of determining whether the predefined energy rule has been satisfied for the particular device further comprises the steps of:
extracting the one or more conditions associated with the predefined energy rule; and
comparing the extracted one or more conditions to the retrieved device information and the current energy information for the particular device to determine whether the conditions have been satisfied.

22. The method of 1, wherein the particular device is IP-enabled.

23. A method for monitoring energy characteristics of a plurality of electronic devices at one or more facilities, comprising the steps of:
retrieving one or more preexisting asset connector modules maintained within an energy management system and capable of retrieving information from the plurality of electronic devices;
for each preexisting asset connector module, remotely connecting to an asset management system responsible for managing a group of electronic devices in the plurality of electronic devices to identify those electronic devices that are managed by the respective asset management system;
retrieving an inventory of electronic devices managed by the respective asset management system;
for each electronic device listed in the inventory, retrieving device information corresponding to characteristics of the respective electronic device from the inventory; and
generating a unique device profile based on the retrieved device information for each respective device and storing the unique device profile in a database,
whereby each unique device profile enables receipt of power consumption information for each device and subsequent remote monitoring and control of each device.

24. The method of claim 23, wherein each asset connector module relates to a particular asset management system type within the one or more facilities.

25. The method of claim 23, wherein the device information is selected from the group comprising: device type, device model, device name, primary device user, physical device location, virtual device location, device capabilities, device operating system, network to which the particular device is connected, business unit of the particular device, whether the particular device is IP-enabled, whether the particular device includes preexisting power sensors.

26. The method of claim 23, wherein the unique device profile for each respective device includes device information merged from a plurality of asset management systems associated with the one or more facilities.

27. The method of claim 23, further comprising the step of, if a unique device profile already exists for a respective device in the plurality of electronic devices, updating the unique device profile to reflect new device information retrieved from the respective asset management system.

28. The method of claim 27, wherein the step of updating the unique device profile to reflect new device information retrieved from the respective asset management system is carried out based on a predefined ranking associated with the respective asset connector module, wherein the unique device profile is only updated if the new device information is retrieved from an asset management system that outranks the respective asset management system from which preexisting device information in the unique device profile was retrieved.

29. The method of claim 28, wherein the predefined ranking corresponds to a relative importance associated with the respective asset connector module as defined by a user of the energy management system.
